(19) United States
(12) Patent Application Publication
(10) Pub. No.: US 2016/0132027 A1
(43) Pub. Date: May 12, 2016

(54) DITHER SWITCHING EXTREMUM SEEKING CONTROL

(71) Applicant: Johnson Controls Technology Company, Holland, MI (US)

(72) Inventors: Yaoyu Li, Franklin, WI (US); John E. Seem, Glendale, WI (US)

(73) Assignee: JOHNSON CONTROLS TECHNOLOGY COMPANY, Holland, MI (US)

(21) Appl. No.: 14/538,700

(22) Filed: Nov. 11, 2014

(51) Int. Cl. G05B 13/02

(52) U.S. Cl. CPC G05B 13/0205

(57) ABSTRACT

A dither switching extremum seeking controller includes a communications interface configured to receive an output signal from a plant and provide a plurality of control inputs to the plant. The controller includes a demodulation module configured to extract, from the output signal, a performance gradient for a variable of interest affected by the plant for each of the control inputs. The controller includes a stabilization module configured to stabilize the extracted performance gradients using a history of previous values for the extracted performance gradients and an integration module configured to generate values for the control inputs. The generated values drive the stabilized performance gradients toward zero. The controller includes a dither signal module configured to perturb the control inputs by adding a dither signal to each control input. The perturbed control inputs are provided to the plant via the communications interface.

### BACKGROUND

The present disclosure relates generally to extremum seeking control strategies. The present disclosure relates more particularly to regulating, via extremum seeking control, a variable of interest (e.g., power production, power consumption, etc.) in an energy system. The present disclosure relates more particularly still to regulating, via extremum seeking control, the amount of air that is flowing through a heating, ventilating, and air conditioning (HVAC) system in order to reduce the amount of mechanical heating or cooling required within an air-handling unit (AHU).

Extremum seeking control (ESC) is a class of self-optimizing control strategies that can dynamically search for the unknown and/or time-varying inputs of a system for optimizing a certain performance index. It can be considered a dynamic realization of gradient searching through the use of dither signals. The gradient of the system output with respect to the system input is typically obtained by slightly perturbing the system operation and applying a demodulation measure. Optimization of system performance can be obtained by driving the gradient towards zero by using an integrator in the closed-loop system. ESC is a non-model based control strategy, meaning that a model for the controlled system is not necessary for ESC to optimize the system.

ESC has been used in many different engineering applications (e.g., combustion, circuitry, mining, aerospace and land-based vehicles, building HVAC, wind and solar energy, etc.) and has been shown to be able to improve the operational efficiency and performance for these engineering applications. A variety of different types of ESC have been developed including dither ESC, switching ESC, sliding-mode ESC, adaptive ESC, among others. Each type of ESC has its respective advantages and disadvantages. For example, switching ESC is generally robust to changes in forward-loop gain and has relatively minor performance degradation at suboptimal gain settings. However, traditional implementations of switching ESC are based on the direct differentiation of system output and input signals, which is an inherently single-input scheme that cannot be applied to multi-input extremum seeking problems. Dither ESC can handle multi-input extremum seeking problems, but has a significant performance degradation at suboptimal gain settings and is therefore much less adaptive than switching ESC.

Traditionally, engineers wishing to implement ESC have been forced to pick one of these types of ESC and accept the disadvantages associated therewith. Fundamental differences and incompatibilities between different types of ESC have prevented multiple types of ESC from being combined or even used together in a single control system. For example, switching ESC acquires gradient information by direct derivation of the input and output signals whereas dither ESC acquires such information via a dither demodulation scheme using a pair of dither and demodulation signals. It would be desirable to develop a new type of ESC that overcomes these and other disadvantages.

### SUMMARY

One implementation of the present disclosure is a dither switching extremum seeking controller. The controller includes a communications interface configured to receive an output signal from a plant and provide a plurality of control inputs to the plant. The output signal is a function of the control inputs. The controller further includes a demodulation module configured to extract, from the output signal, a performance gradient for a variable of interest affected by the plant for each of the control inputs. The controller further includes a stabilization module configured to stabilize the extracted performance gradients using a history of previous values for the extracted performance gradients and an integration module configured to generate values for the control inputs. The generated values drive the stabilized performance gradients toward zero. The controller further includes a dither signal module configured to perturb the control inputs by adding a dither signal to each control input. The perturbed control inputs are provided to the plant via the communications interface.

In some embodiments, the controller includes a plurality of control loops each configured to independently perform the extract, stabilize, generate, and perturb operations for one of the control inputs.

In some embodiments, the dither signal module is configured to generate a plurality of dither signals. Each dither signal has a different dither frequency. The dither signal module may add the plurality of generated dither signals to the control inputs such that each control input is perturbed by a dither signal having a different dither frequency.

In some embodiments, the demodulation module is configured to isolate an effect of each dither signal on the output signal and use the isolated effect of each dither signal to determine a relationship between each of the control inputs and the variable of interest. In some embodiments, isolating the effect of each dither signal on the output signal comprises includes filtering the output signal using a plurality of parallel high-pass filters, applying a demodulation signal to an output of each high-pass filter to generate a plurality of demodulated output signals, and filtering the plurality of demodulated output signals using a plurality of parallel low-pass filters. In some embodiments, applying a demodulation signal to the output of each high-pass filter includes generating a plurality of demodulation signals and multiplying the generated demodulation signals with the outputs from the high-pass filters such that each of the outputs from the high-pass filters is multiplied by a different demodulation signal. Each demodulation signal may be configured to maximize a cross-correlation between the demodulation signal and the output of the high-pass filter with which the demodulation signal is multiplied.

In some embodiments, the stabilization module is configured to use a plurality of parallel stabilization elements to independently process and stabilize each of the extracted performance gradients. The stabilization elements may include at least one of a hysteresis device and a flip-flop device.

In some embodiments, the integration module is configured to use a plurality of parallel integrators to independently process each of the stabilized performance gradients. Each stabilized performance gradient may correspond to one of the control inputs. The integration module may generate a value for each of the control inputs that drives the corresponding stabilized performance gradient to zero.

Another implementation of the present disclosure is a method for regulating a variable of interest affected by a plant using dither switching extremum seeking control. The method includes receiving an output signal from the plant at a communications interface of a controller. The method further includes extracting, from the output signal by a demodulation module of the controller, a performance gradient for the variable of interest affected by the plant for each of a plurality of control inputs to the plant. The method further includes stabilizing, by a stabilization module of the controller, the extracted performance gradients using a history of previous values for the extracted performance gradients. The method further includes generating, by an integration module of the controller, values for the plurality of control inputs. The generated values drive the stabilized performance gradients toward zero. The method further includes perturbing, by a dither signal module of the controller, the plurality of control inputs by adding a dither signal to each control input. The method further includes providing the perturbed control inputs to the plant via the communications interface of the controller. The output signal from the plant is a function of the perturbed control inputs.

In some embodiments, the controller includes a plurality of control loops and each of the control loops independently performs the extracting, stabilizing, generating, and perturbing steps for one of the control inputs.

In some embodiments, perturbing the plurality of control inputs includes generating a plurality of dither signals. Each dither signal may have a different dither frequency. The method may include adding the plurality of generated dither signals to the control inputs such that each control input is perturbed by a dither signal having a different dither frequency.

In some embodiments, extracting the performance gradient includes isolating an effect of each dither signal on the output signal and using the isolated effect of each dither signal to determine a relationship between each of the control inputs and the variable of interest. In some embodiments, isolating the effect of each dither signal on the output signal includes filtering the output signal using a plurality of parallel high-pass filters, applying a demodulation signal to an output of each high-pass filter to generate a plurality of demodulated output signals, and filtering the plurality of demodulated output signals using a plurality of parallel low-pass filters. In some embodiments, applying a demodulation signal to the output of each high-pass filter includes generating a plurality of demodulation signals and multiplying the generated demodulation signals with the outputs from the high-pass filters such that each of the outputs from the high-pass filters is multiplied by a different demodulation signal. Each demodulation signal may be configured to maximize a cross-correlation between the demodulation signal and the output of the high-pass filter with which the demodulation signal is multiplied.

In some embodiments, stabilizing the extracted performance gradients includes using a plurality of parallel stabilization elements to independently process and stabilize each of the extracted performance gradients. The stabilization elements may include at least one of a hysteresis device and a flip-flop device.

In some embodiments, generating values for the plurality of control inputs includes using a plurality of parallel integrators to independently process each of the stabilized performance gradients. Each stabilized performance gradient may correspond to one of the control inputs. Generating values for the plurality of control inputs may further include generating, by each of the integrators, a value for one of the control inputs that drives the corresponding stabilized performance gradient to zero.

Another implementation of the present disclosure is a dither switching extremum seeking controller. The controller includes a dither signal module configured to perturb a control input for a plant using a dither signal, a demodulation module configured to extract a performance gradient from an output signal from the plant, an integration module configured to generate a value for the control input that drives the extracted performance gradient toward zero, and an adaptive tuning module configured to adaptively tune a control parameter used by the controller based on an observed effect of the dither signal on the output signal from the plant.

In some embodiments, the adaptive tuning module is configured to identify a dithered output amplitude of an oscillation in the output signal caused by the dither signal and compare the dithered output amplitude to a threshold value. The adaptive tuning module may, based on a result of the comparison, adjust an integral gain parameter used by the integration module to generate the value for the control input.

In some embodiments, the demodulation module is configured to filter the output signal from the plant using a high-pass filter and apply a demodulation signal to an output of the high-pass filter. In some embodiments, the adaptive tuning module is configured to adjust a phase compensation of the demodulation signal to optimize a cross-correlation between the demodulation signal and the output of the high-pass filter.

In some embodiments, the controller further includes a system identification module configured to estimate a measurement noise of the plant and an operating parameters generator module configured to calculate an amplitude for the dither signal based on the estimated measurement noise.

In some embodiments, calculating the amplitude for the dither signal includes identifying a dithered output amplitude of an oscillation in the output signal caused by the dither signal and calculating a gain value based on the dithered output amplitude. The gain value may be calculated such that applying the gain value to the dithered output amplitude results in an amplitude of at least twice the estimated measurement noise. Calculating the amplitude for the dither signal may further include applying the calculated gain value to an existing dither signal amplitude to generate a new amplitude for the dither signal.

Another implementation of the present disclosure is a method for adaptively tuning a dither switching extremum seeking controller. The method includes perturbing, by a dither signal module of the controller, a control input for a plant using a dither signal. The method further includes extracting, by a demodulation module of the controller, a performance gradient from an output signal from the plant. The method further includes generating, by an integration module of the controller, a value for the control input that drives the extracted performance gradient toward zero. The method further includes adaptively tuning, by an adaptive tuning module of the controller, a control parameter used by the controller based on an observed effect of the dither signal on the output signal from the plant.

In some embodiments, adaptively tuning the control parameter includes identifying a dithered output amplitude of an oscillation in the output signal caused by the dither signal, comparing the dithered output amplitude to a threshold value, and based on a result of the comparison, adjusting an integral gain parameter used by the integration module to generate the value for the control input.

In some embodiments, extracting the performance gradient includes filtering the output signal from the plant using a high-pass filter and applying a demodulation signal to an output of the high-pass filter. In some embodiments, adaptively tuning the control parameter comprises adjusting a phase compensation of the demodulation signal to optimize a cross-correlation between the demodulation signal and the output of the high-pass filter.

In some embodiments, the method includes estimating, by a system identification module of the controller, a measurement noise of the plant. The method may further include calculating, by an operating parameters generator module of the controller, an amplitude for the dither signal based on the estimated measurement noise.

In some embodiments, calculating the amplitude for the dither signal includes identifying a dithered output amplitude of an oscillation in the output signal caused by the dither signal and calculating a gain value based on the dithered output amplitude. The gain value may be calculated such that applying the gain value to the dithered output amplitude results in an amplitude of at least twice the estimated measurement noise. Calculating the amplitude for the dither signal may further include applying the calculated gain value to an existing dither signal amplitude to generate a new amplitude for the dither signal.

Those skilled in the art will appreciate that the summary is illustrative only and is not intended to be in any way limiting. Other aspects, inventive features, and advantages of the devices and/or processes described herein, as defined solely by the claims, will become apparent in the detailed description set forth herein and taken in conjunction with the accompanying drawings.

### BRIEF DESCRIPTION OF THE DRAWINGS

FIG. 1 is a drawing of a building 10 serviced by a heating, ventilation, and air conditioning system (HVAC) system, according to an exemplary embodiment.

FIG. 2 is a block diagram illustrating a portion of the HVAC system of FIG. 1 in greater detail, according to an exemplary embodiment.

FIG. 3A is a block diagram of an extremum seeking control (ESC) loop that may be used to implement an ESC strategy to control a plant such as the HVAC system of FIG. 1, according to an exemplary embodiment.

FIG. 3B is a block diagram of a dither switching extremum seeking control (DSESC) loop that may be used to implement a DSESC strategy to provide improved control over the plant of FIG. 3A, according to an exemplary embodiment.

FIG. 4 is a block diagram illustrating the DSESC loop of FIG. 3B in greater detail and showing details of both the dither switching extremum seeking controller and the plant, according to an exemplary embodiment.

FIG. 5 is a block diagram illustrating the dither switching extremum seeking controller of FIG. 4 in greater detail, according to an exemplary embodiment.

FIG. 6 is a flowchart of a process for regulating a variable of interest affected by a plant using dither switching extremum seeking control, according to an exemplary embodiment.

FIG. 7 is a flowchart of a process for adaptively tuning a dither switching extremum seeking controller, according to an exemplary embodiment.

FIGS. 8-14 are a series of graphs illustrating the results of a simulation study using the dither switching extremum seeking controller of FIG. 5 to control a simulated plant, according to an exemplary embodiment.

### DETAILED DESCRIPTION

Referring generally to the figures, dither switching extremum seeking control (DSESC) systems and methods are shown, according to various exemplary embodiments. In general, extremum seeking control (ESC) is a class of self-optimizing control strategies that can dynamically search for the unknown and/or time-varying inputs of a system for optimizing a certain performance index. It can be considered a dynamic realization of gradient searching through the use of dither signals. The gradient of the system output with respect to the system input is typically obtained by slightly perturbing the system operation and applying a demodulation measure. Optimization of system performance can be obtained by driving the gradient towards zero by using an integrator in the closed-loop system. ESC is a non-model based control strategy, meaning that a model for the controlled system is not necessary for ESC to optimize the system. Various implementations of ESC are described in detail in U.S. Pat. No. 8,473,080, U.S. Pat. No. 7,827,813, U.S. Pat. No. 8,027,742, U.S. Pat. No. 8,200,345, and U.S. Pat. No. 8,200,344, each of which is incorporated by reference herein.

The current invention is a new type of ESC (i.e., dither switching ESC) that provides the advantages of both dither ESC and switching ESC in a new ESC framework. Advantageously, dither switching ESC (DSESC) is capable of handling multiple inputs and is adaptive to changes in system parameters such as forward loop gain and phase compensation. DSESC may be implemented using a DSESC controller as described below.

In operation, the DSESC controller modifies the control inputs to a plant by adding a dither signal (e.g., a small-amplitude periodic signal) to each control input. In some embodiments, each control input is modified by a different dither signal having a different dither frequency. The DSESC controller passes an output signal from the plant through multiple parallel high-pass filters (e.g., one for each dither signal) and applies a demodulation signal to the output of each high-pass filter. The frequency and phase of each demodulation signal may be selected to maximize the cross-correlation between the demodulation signal and the output of the corresponding high-pass filter. Using multiple different dither and demodulation signals allows each input channel to be independently isolated by defining different dither frequencies for each dither/demodulation signal pair. Advantageously, this functionality allows the DSESC controller to attribute a change in the output signal to a change in a particular input signal. Changes in the output signal caused by each of the control inputs can be distinguished from each other and distinguished from external disturbances and/or process noise.

In some embodiments, the DSESC controller multiplies the output of each high-pass filter by a different demodulation signal and provides each product to a low-pass filter (e.g., one for each demodulation product). The cutoff frequencies of the high-pass and low-pass filters may be selected to extract gradient information from the dither system output. The output of each low-pass filter may then be passed through hysteresis and flip/flop devices. The hysteresis and flip/flop devices function to stabilize the signals while rejecting the negative impact of measurement noise. The DSESC controller may optimize system performance by providing the outputs from the hysteresis and flip/flop devices to integrators configured to drive the extracted gradients towards zero.

Advantageously, the DSESC controller can automatically and adaptively determine optimal parameters for a multi-input ESC system. For example, the DSESC controller may estimate the input dynamics and measurement noise of the plant using open loop tests (e.g., step/bump tests, double pulse tests, a pseudorandom binary sequence followed by system identification, etc.). The DSESC controller may select dither frequencies and amplitudes for the dither signals to distinguish the dither signals from each other and from any measurement/process noise. The DSESC controller may perform open loop tests to tune the phase compensation for each demodulation signal to provide maximum cross-correlation between the high-pass filter outputs and the demodulation signals.

The DSESC controller may use the automatically-determined system parameters to operate the control system in a closed loop mode. For example, the DSESC controller may increase the gain of each integrator in closed loop operation until the effect of the corresponding dither signal is detected in the output signal from the plant. The DSESC controller may also adaptively adjust the phase compensation of each demodulation signal in closed loop operation to maximize the cross-correlation between demodulation signal and the output of the corresponding high-pass filter.

Although DSESC systems and methods of the present disclosure describe DSESC primarily in the context of a building HVAC system, it is understood that DSESC may be generally applicable to any type of control system that optimizes or regulates a variable of interest. For example, the DSESC systems and methods of the present disclosure may be used to optimize an amount of energy produced by various types of energy producing systems or devices (e.g., power plants, steam or wind turbines, solar panels, combustion systems, etc.) and/or to optimize an amount of energy consumed by various types of energy consuming systems or devices (e.g., electronic circuitry, mechanical equipment, aerospace and land-based vehicles, building equipment, HVAC devices, etc.). In various implementations, DSESC be used in any type of controller that functions to achieve a setpoint for a variable of interest (e.g., by minimizing a difference between a measured or calculated input and a setpoint) and/or optimize a variable of interest (e.g., maximize or minimize an output variable).

It is understood that DSESC can be readily implemented in various types of controllers (e.g., motor controllers, power controllers, fluid controllers, HVAC controllers, lighting controllers, chemical controllers, process controllers, etc.) and various types of control systems (e.g., closed-loop control systems, open-loop control systems, feedback control systems, feed-forward control systems, etc.) as may be suitable for various applications. All such implementations should be considered within the scope of the present disclosure. It is also understood that the invention is not limited to the details or methodology set forth in the description or illustrated in the figures. The terminology used in the present disclosure is for the purpose of description only and should not be regarded as limiting.

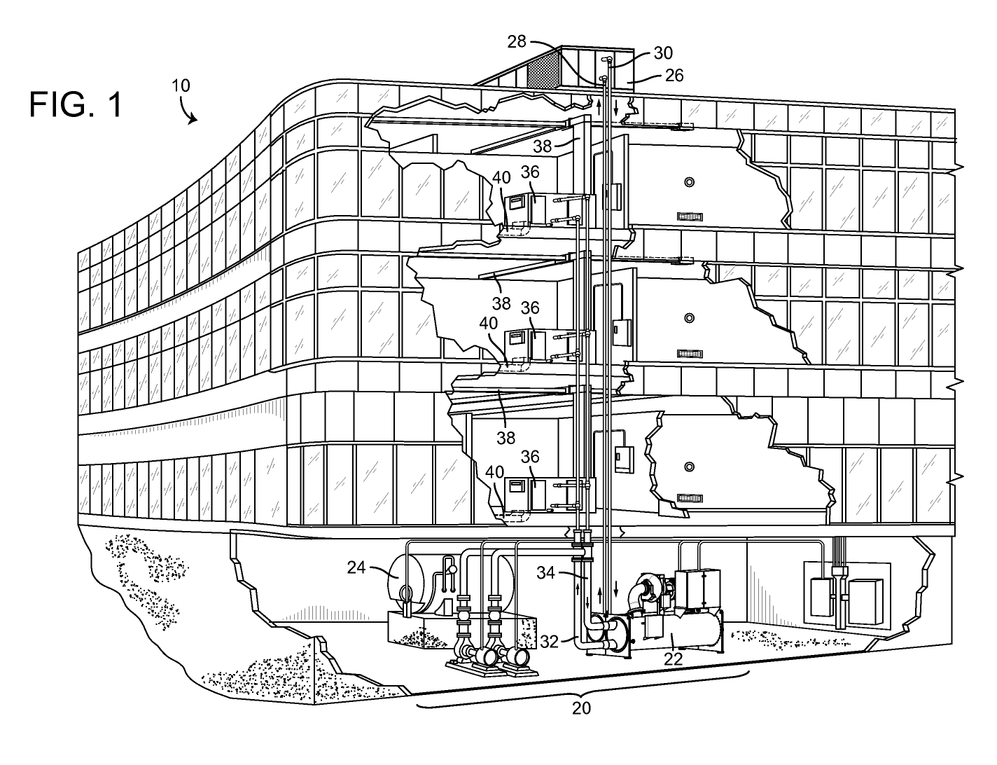

Referring now to FIG. 1, a perspective view of a building 10 is shown. Building 10 is serviced by a HVAC system 20. HVAC system 20 is shown to include a chiller 22, a boiler 24, a rooftop cooling unit 26, and a plurality of air-handling units (AHUs) 36. HVAC system 20 uses a fluid circulation system to provide heating and/or cooling for building 10. The circulated fluid may be cooled in chiller 22 or heated in boiler 24, depending on whether cooling or heating is required. Boiler 24 may add heat to the circulated fluid by burning a combustible material (e.g., natural gas). Chiller 22 may place the circulated fluid in a heat exchange relationship with another fluid (e.g., a refrigerant) in a heat exchanger (e.g., an evaporator). The refrigerant removes heat from the circulated fluid during an evaporation process, thereby cooling the circulated fluid.

The circulated fluid from chiller 22 or boiler 24 may be transported to AHUs 36 via piping 32. AHUs 36 may place the circulated fluid in a heat exchange relationship with an airflow passing through AHUs 36. For example, the airflow may be passed over piping in fan coil units or other air conditioning terminal units through which the circulated fluid flows. AHUs 36 may transfer heat between the airflow and the circulated fluid to provide heating or cooling for the airflow. The heated or cooled air may be delivered to building 10 via an air distribution system including air supply ducts 38 and may return to AHUs 36 via air return ducts 40. In FIG. 1, HVAC system 20 is shown to include a separate AHU 36 on each floor of building 10. In other embodiments, a single AHU (e.g., a rooftop AHU) may supply air for multiple floors or zones. The circulated fluid from AHUs 36 may return to chiller 22 or boiler 24 via piping 34.

In some embodiments, the refrigerant in chiller 22 is vaporized upon absorbing heat from the circulated fluid. The vapor refrigerant may be provided to a compressor within chiller 22 where the temperature and pressure of the refrigerant are increased (e.g., using a rotating impeller, a screw compressor, a scroll compressor, a reciprocating compressor, a centrifugal compressor, etc.). The compressed refrigerant may be discharged into a condenser within chiller 22. In some embodiments, water (or another chilled fluid) flows through tubes in the condenser of chiller 22 to absorb heat from the refrigerant vapor, thereby causing the refrigerant to condense. The water flowing through tubes in the condenser may be pumped from chiller 22 to a rooftop cooling unit 26 via piping 28. Cooling unit 26 may use fan driven cooling or fan driven evaporation to remove heat from the water. The cooled water in rooftop unit 26 may be delivered back to chiller 22 via piping 30 and the cycle repeats.

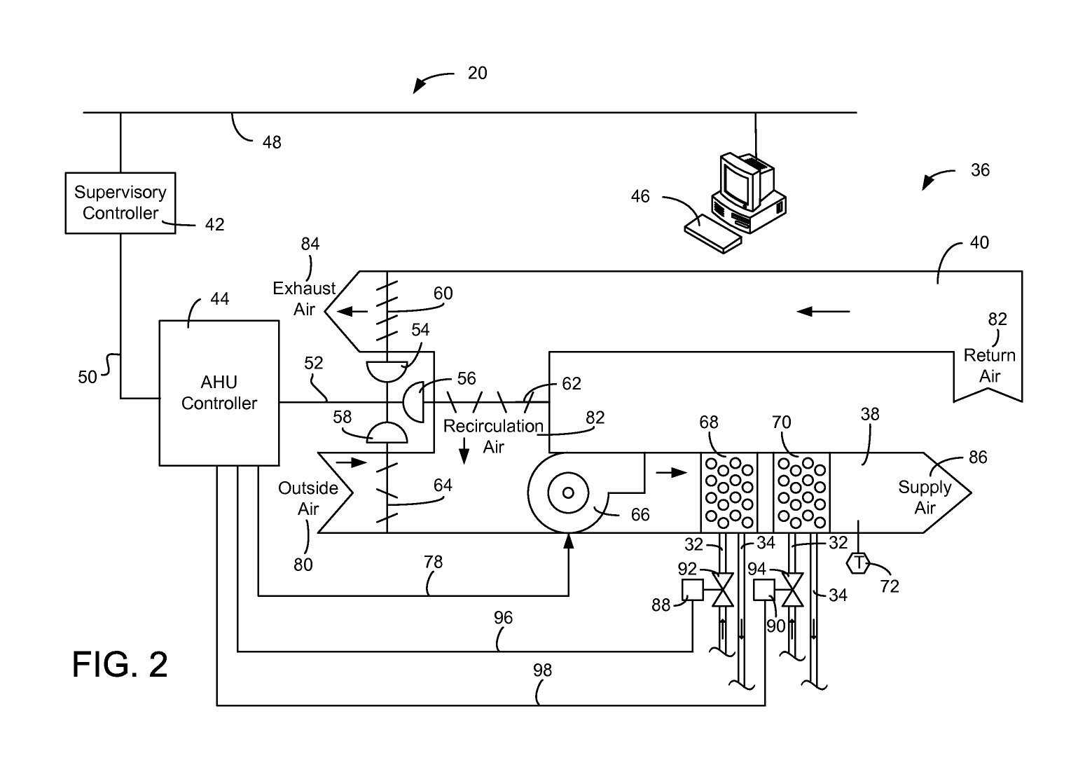

Referring now to FIG. 2, a block diagram of a portion of HVAC system 20 is shown, according to an exemplary embodiment. In FIG. 2, AHU 36 is shown as an economizer type air handling unit. Economizer type air handling units vary the amount of outside air and return air used by the air handling unit for heating or cooling. For example, AHU 36 may receive return air 82 from building 10 via return air duct 40 and may deliver supply air 86 to building 10 via supply air duct 38. AHU 36 may be configured to operate exhaust air damper 60, mixing damper 62, and outside air damper 64 to control an amount of outside air 80 and return air 82 that combine to form supply air 86. Any return air 82 that does not pass through mixing damper 62 may be exhausted from AHU 36 through exhaust damper 60 as exhaust air 84.

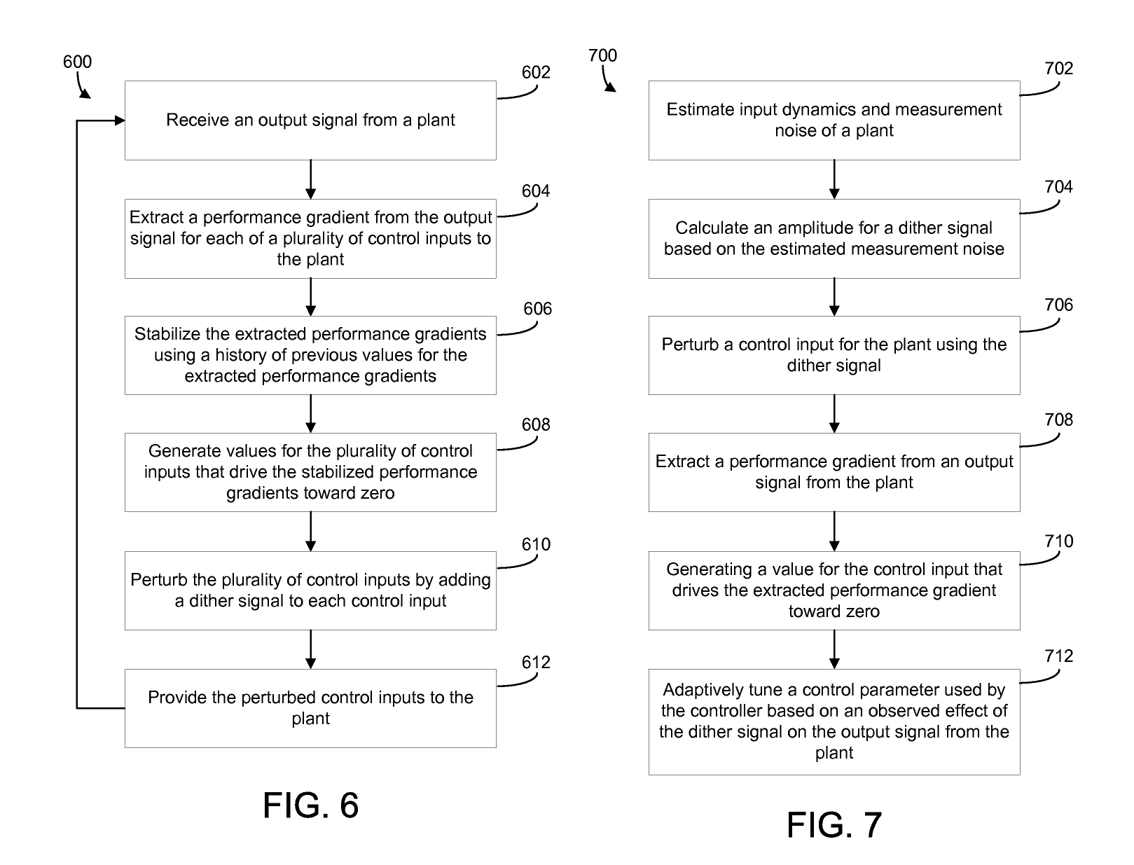

Each of dampers 60-64 may be operated by an actuator. As shown in FIG. 2, exhaust air damper 60 is operated by actuator 54, mixing damper 62 is operated by actuator 56, and outside air damper 64 is operated by actuator 58. Actuators 54-58 may communicate with an AHU controller 44 via a communications link 52. AHU controller 44 may be an economizer controller configured to use one or more control algorithms (e.g., state-based algorithms, ESC algorithms, PID control algorithms, model predictive control algorithms, etc.) to control actuators 54-58. An exemplary dither switching ESC method that may be used by AHU controller 44 is described in greater detail with reference to FIG. 6.

Actuators 54-58 may receive control signals from AHU controller 44 and may provide feedback signals to AHU controller 44. Feedback signals may include, for example, an indication of a current actuator or damper position, an amount of torque or force exerted by the actuator, diagnostic information (e.g., results of diagnostic tests performed by actuators 54-58), status information, commissioning information, configuration settings, calibration data, and/or other types of information or data that may be collected, stored, or used by actuators 54-58.

Still referring to FIG. 2, AHU 36 is shown to include a cooling coil 68, a heating coil 70, and a fan 66. In some embodiments, cooling coil 68, heating coil 70, and fan 66 are positioned within supply air duct 38. Fan 66 may be configured to force supply air 86 through cooling coil 68 and/or heating coil 70. AHU controller 44 may communicate with fan 66 via communications link 78 to control a flow rate of supply air 86. Cooling coil 68 may receive a chilled fluid from chiller 22 via piping 32 and may return the chilled fluid to chiller 22 via piping 34. Valve 92 may be positioned along piping 32 or piping 34 to control an amount of the chilled fluid provided to cooling coil 68. Heating coil 70 may receive a heated fluid from boiler 24 via piping 32 and may return the heated fluid to boiler 24 via piping 34. Valve 94 may be positioned along piping 32 or piping 34 to control an amount of the heated fluid provided to heating coil 70.

Each of valves 92-94 may be controlled by an actuator. As shown in FIG. 2, valve 92 is controlled by actuator 88 and valve 94 is controlled by actuator 90. Actuators 88-90 may communicate with AHU controller 44 via communications links 96-98. Actuators 88-90 may receive control signals from AHU controller 44 and may provide feedback signals to controller 44. In some embodiments, AHU controller 44 receives a measurement of the supply air temperature from a temperature sensor 72 positioned in supply air duct 38 (e.g., downstream of cooling coil 68 and heating coil 70). However, temperature sensor 72 is not required and may not be included in some embodiments.

AHU controller 44 may operate valves 92-94 via actuators 88-90 to modulate an amount of heating or cooling provided to supply air 86 (e.g., to achieve a setpoint temperature for supply air 86 or to maintain the temperature of supply air 86 within a setpoint temperature range). The positions of valves 92-94 affect the amount of cooling or heating provided to supply air 86 by cooling coil 68 or heating coil 70 and may correlate with the amount of energy consumed to achieve a desired supply air temperature. In various embodiments, valves 92-94 may be operated by AHU controller 44 or a separate controller for HVAC system 20.

AHU controller 44 may monitor the positions of valves 92-94 via communications links 96-98. AHU controller 44 may use the positions of valves 92-94 as the variable to be optimized using an ESC control technique. AHU controller 44 may determine and/or set the positions of dampers 60-64 to achieve an optimal or target position for valves 92-94. The optimal or target position for valves 92-94 may be the position that corresponds to the minimum amount of mechanical heating or cooling used by HVAC system 20 to achieve a setpoint supply air temperature (e.g., minimum fluid flow through valves 92-94).

Still referring to FIG. 2, HVAC system 20 is shown to include a supervisory controller 42 and a client device 46. Supervisory controller 42 may include one or more computer systems (e.g., servers, BAS controllers, etc.) that serve as enterprise level controllers, application or data servers, head nodes, master controllers, or field controllers for HVAC system 20. Supervisory controller 42 may communicate with multiple downstream building systems or subsystems (e.g., an HVAC system, a security system, etc.) via a communications link 50 according to like or disparate protocols (e.g., LON, BACnet, etc.).

In some embodiments, AHU controller 44 receives information (e.g., commands, setpoints, operating boundaries, etc.) from supervisory controller 42. For example, supervisory controller 42 may provide AHU controller 44 with a high fan speed limit and a low fan speed limit. A low limit may avoid frequent component and power taxing fan start-ups while a high limit may avoid operation near the mechanical or thermal limits of the fan system. In various embodiments, AHU controller 44 and supervisory controller 42 may be separate (as shown in FIG. 2) or integrated. In an integrated implementation, AHU controller 44 may be a software module configured for execution by a processor of supervisory controller 42.

Client device 46 may include one or more human-machine interfaces or client interfaces (e.g., graphical user interfaces, reporting interfaces, text-based computer interfaces, client-facing web services, web servers that provide pages to web clients, etc.) for controlling, viewing, or otherwise interacting with HVAC system 20, its subsystems, and/or devices. Client device 46 may be a computer workstation, a client terminal, a remote or local interface, or any other type of user interface device. Client device 46 may be a stationary terminal or a mobile device. For example, client device 46 may be a desktop computer, a computer server with a user interface, a laptop computer, a tablet, a smartphone, a PDA, or any other type of mobile or non-mobile device.

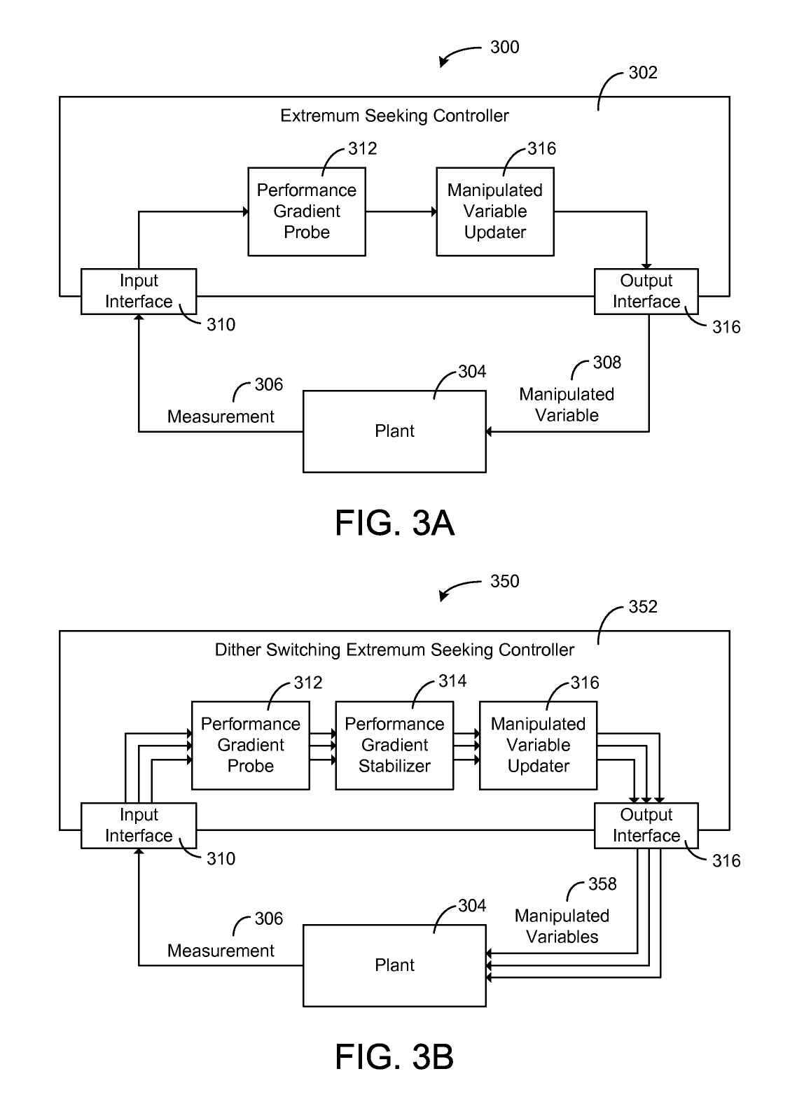

Referring now to FIG. 3A, a block diagram of an extremum seeking control (ESC) loop 300 is shown, according to an exemplary embodiment. ESC loop 300 is shown to include an extremum seeking controller 302 and a plant 304. A plant in control theory is the combination of a process and one or more mechanically-controlled outputs. For example, plant 304 may be an air handling unit configured to control temperature within a building space via one or more mechanically-controlled actuators and/or dampers. In various embodiments, plant 304 may include a chiller operation process, a damper adjustment process, a mechanical cooling process, a ventilation process, or any other process where a variable is manipulated to affect an output from plant 304.

Extremum seeking controller 302 uses extremum seeking control logic to modulate its output in response to a changing measurement 306 received from plant 304 via input interface 310. Measurements from plant 304 may include, but are not limited to, information received from sensors about the state of plant 304 or control signals sent to other devices in the system. In some embodiments, measurement 306 is a measured or observed position of one of valves 92-94. In other embodiments, measurement 306 is a measured or calculated amount of power consumption, a fan speed, a damper position, a temperature, or any other variable that can be measured or calculated by plant 304. Measurement 306 may be the variable that extremum seeking controller 302 seeks to optimize via an extremum seeking control process. Measurement 306 may be output by plant 304 or observed at plant 304 (e.g., via a sensor) and provided extremum seeking controller at input interface 310.

Input interface 310 provides measurement 306 to performance gradient probe 312 to detect the performance gradient. The performance gradient may indicate a slope of the function y=f(x), where y represents measurement 306 and x represents manipulated variable 308. When the performance gradient is zero, measurement 306 has an extremum value (e.g., a maximum or minimum). Therefore, extremum seeking controller 302 can optimize the value of measurement 306 by driving the performance gradient to zero. Manipulated variable updater 316 produces an updated manipulated variable 308 based upon the performance gradient. In an exemplary embodiment, manipulated variable updater 316 includes an integrator to drive the performance gradient to zero. Manipulated variable updater 316 then provides an updated manipulated variable 308 to plant 304 via output interface 316. In some embodiments, manipulated variable 308 is provided to one of dampers 60-64 (FIG. 2) or an actuator affecting dampers 60-64 as a control signal via output interface 316. Plant 304 may use manipulated variable 308 as a setpoint to adjust the position of dampers 60-64 and thereby control the relative proportions of outdoor air 80 and recirculation air 82 provided to a temperature-controlled space.

Referring now to FIG. 3B, a block diagram of a dither switching extremum seeking control (DSESC) loop 350 is shown, according to an exemplary embodiment. DSESC loop 350 is shown to include a dither switching extremum seeking controller 352 and plant 304. In DSESC loop 350, measurement 306 is a function of several manipulated variables 358 provided as inputs to plant 304. Manipulated variables 358 may include any controlled input provided to plant 304 to affect the value of measurement 306. For example, manipulated variables 358 may include setpoints for multiple chillers, dampers, actuators, or other components of HVAC system 20 that can be operated to affect the value of measurement 306 (e.g., a measured supply air temperature, a measured power consumption, etc.). Controller 352 includes several of the same components as controller 300 (e.g., performance gradient probe 312, manipulated variable updater 316, input interface 310, and output interface 316) and an additional component shown as performance gradient stabilizer 314.

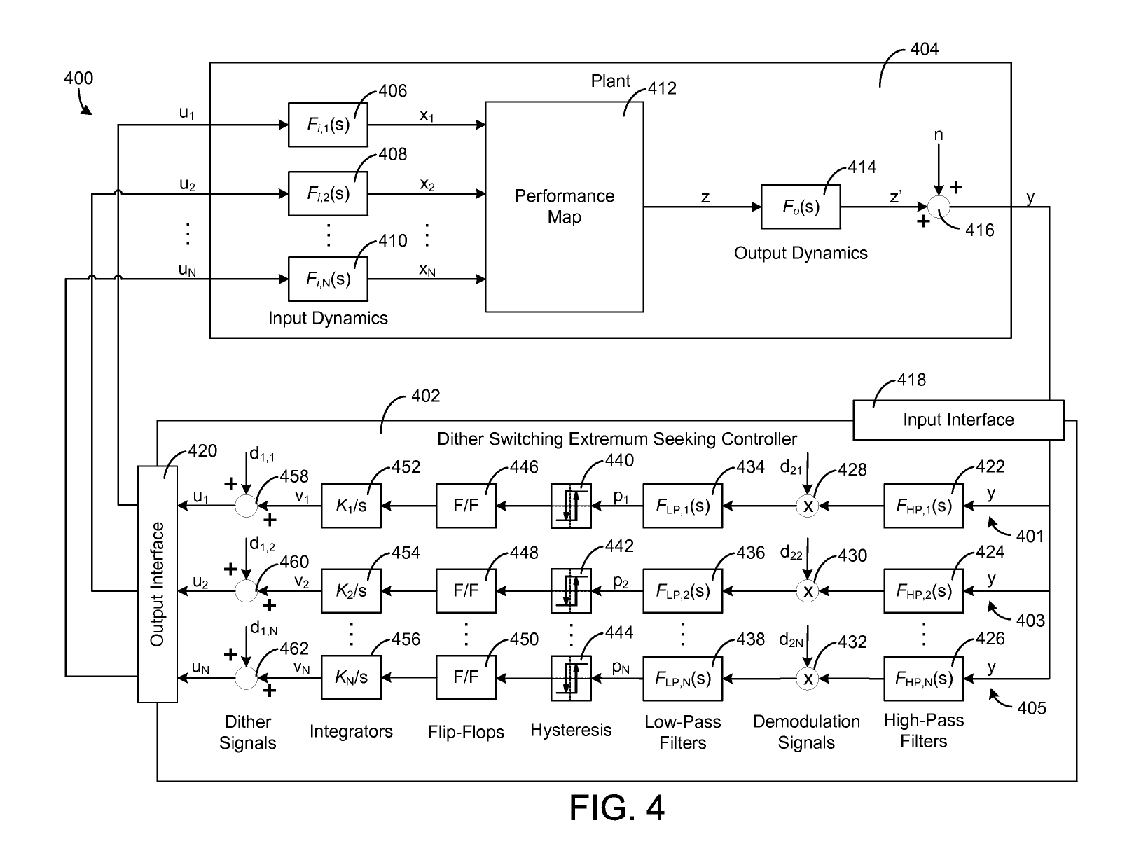

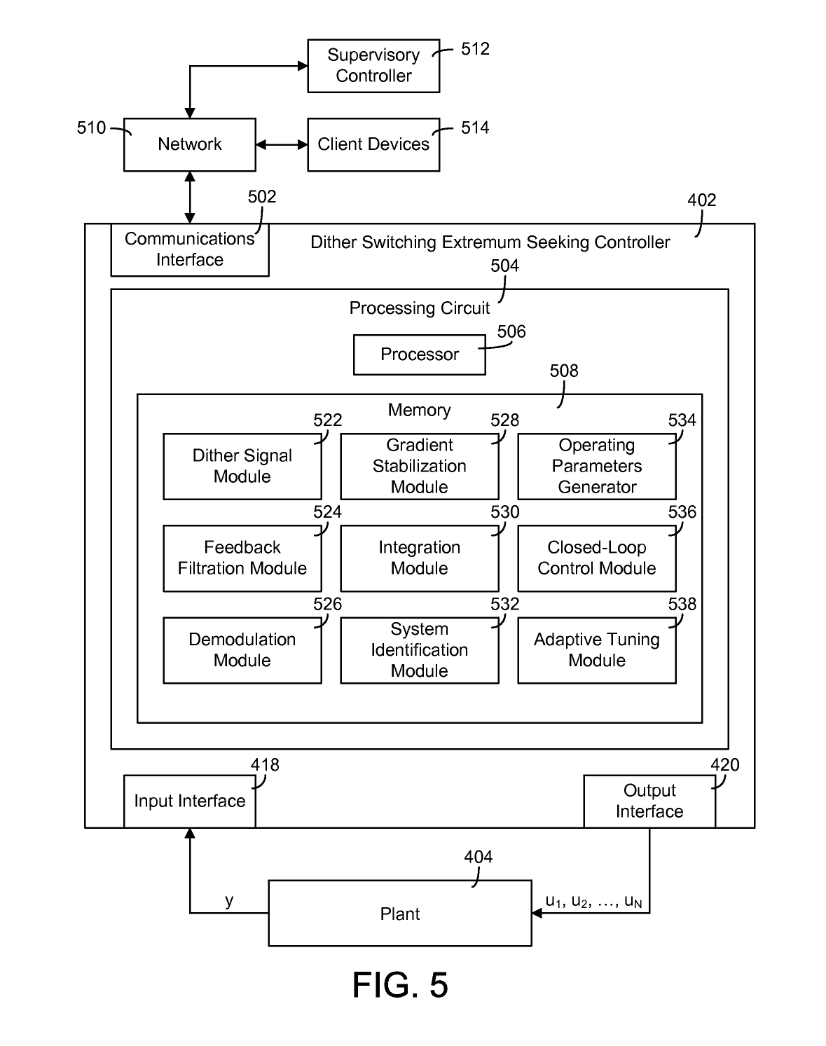

Controller 352 may be configured to perform a dither-demodulation process to determine the effect of manipulated variables 358 on measurement 306. For example, manipulated variable updater 316 may add dither signals to each of manipulated variables 358. In some embodiments, each of manipulated variables 358 is modified by a different dither signal having a different dither frequency. Performance gradient probe 312 may pass measurement 306 through multiple parallel high-pass filters (e.g., one for each dither signal) and apply a demodulation signal to the output of each high-pass filter. The frequency and phase of each demodulation signal may be selected to maximize the cross-correlation between the demodulation signal and the output of the corresponding high-pass filter. Performance gradient probe 312 may multiply the output of each high-pass filter by a different demodulation signal and provide each product to a low-pass filter. The cutoff frequencies of the high-pass and low-pass filters may be selected to extract gradient information from measurement 306. The dither-demodulation process is described in greater detail with reference to FIGS. 4-5.

In DSESC loop 350, the outputs from performance gradient probe 312 are provided to a performance gradient stabilizer 314. Performance gradient stabilizer 314 may include, for example, hysteresis devices and/or flip/flop devices configured to stabilize the performance gradients while rejecting the negative impact of measurement noise. Performance gradient stabilizer 314 provides the stabilized performance gradients to manipulated variable updater 316, which uses integrators to drive the performance gradients to zero.

Referring now to FIG. 4, a block diagram of a dither switching extremum seeking control (DSESC) system 400 is shown, according to an exemplary embodiment. DSESC system 400 is shown to include a plant 404 and a dither switching extremum seeking controller 402. Controller 402 uses a dither switching extremum seeking control strategy to optimize an output y from plant 404. Optimizing output y may include minimizing y, maximizing y, controlling y to achieve a setpoint, or otherwise regulating the value of output y.

Plant 404 may be the same or similar to plant 304, as described with reference to FIGS. 3A-B. For example, plant 404 may be a combination of a process and one or more mechanically-controlled outputs. In some embodiments, plant 404 is an air handling unit configured to control temperature within a building space via one or more mechanically-controlled actuators and/or dampers. In other embodiments, plant 404 may include a chiller operation process, a damper adjustment process, a mechanical cooling process, a ventilation process, or any other process that generates an output based on one or more control inputs. Plant 404 may be represented mathematically as a combination of input dynamics 406-410, a performance map 412, output dynamics 414, and noise n. In some embodiments, input dynamics 406-410 are linear time-invariant (LTI) input dynamics and output dynamics 414 are LTI output dynamics. Performance map 412 may be a static nonlinear performance map. Noise n may be process noise, measurement noise, or a combination of both. The actual mathematical model for plant 404 does not need to be known in order to apply dither switching ESC and is illustrative only.

Plant 404 receives a plurality of control inputs (e.g., u₁, u₂, . . . , u_{N}) from output interface 420 of dither switching extremum seeking controller 402. In some embodiments, each of input dynamics 406-410 receives separate control input. For example, input dynamics 406 is shown receiving a first control input u₁, input dynamics 408 is shown receiving a second control input u₂, and input dynamics 410 is shown receiving a nth control input u_{N}, where N is the total number of control inputs provided to plant 404. Each of input dynamics 406-410 uses one of the control inputs uⱼ to generate a function signal xⱼ based on the control input (e.g., xⱼ=f(uⱼ), where uⱼ and xⱼ represent the control input and function signal for the jth input to plant 404 and j=1 . . . N. For example, input dynamics 406 is shown producing a first function signal x₁ as a function of the first control input u₁, input dynamics 408 is shown producing a second function signal x₂ as a function of the second control input u₂, and input dynamics 410 is shown producing a nth function signal x_{N} as a function of the nth control input u_{N}.

Function signals x₁, x₂, . . . , x_{N} may be passed to performance map 412 which generates an output signal z as a function of the function signals (i.e., z=f(x₁, x₂, . . . , x_{N})). Dither switching extremum seeking controller 402 may seek to find values for x₁, x₂, . . . , x_{N} and/or u₁, u₂, . . . , u_{N} that optimize the output z of performance map 412. The output signal z may be passed through output dynamics 414 to produce signal z′, which is modified by noise n to produce a measured output y (e.g., y=z′+n). Measured output y is provided as an output from plant 404 and received at input interface 418 of dither switching extremum seeking controller 402.

Still referring to FIG. 4, dither switching extremum seeking controller 402 is shown receiving measured output y at input interface 418 and providing measured output y to a plurality of control loops 401, 403, and 405. Dither switching extremum seeking controller 402 may include a control loop for each of the N control inputs u₁, u₂, . . . , u_{N} provided to plant 404. Each of control loops 401-405 may be configured to produce a performance gradient pⱼ using a dither-demodulation process, where pⱼ represents the performance gradient for the jth control input and j=1 . . . N. For example, loop 401 may be configured to generate control input u₁ and extract a first performance gradient p₁ (i.e., a performance gradient for input u₁) from measured output y, loop 403 may be configured to generate control input u₂ and extract a second performance gradient p₂ (i.e., a performance gradient for input u₂) from measured output y, and loop 405 may be configured to generate control input u_{N} and extract a nth performance gradient p_{N} (i.e., a performance gradient for input u_{N}) from measured output y.

The first step of the dither-demodulation process is performed at processing elements 458-462 and includes using dither signals to perturb the control inputs u₁, u₂, . . . , u_{N} to plant 404. Each control input uⱼ is perturbed by adding a dither signal d_{1,j} to the output vⱼ of integrators 452-456 (e.g., uⱼ=vⱼ+d_{1,j} where j=1 . . . N). In some embodiments, each signal vⱼ is modified by a different dither signal d_{1,j} having a different dither frequency. The perturbed control inputs u₁, u₂, . . . , u_{N} are provided to plant 404 and used by plant 404 to generate measured output y as previously described.

The second step of the dither-demodulation process is performed by high-pass filters 422-426, demodulation elements 428-432, and low-pass filters 434-438. Each of control loops 401-405 provides the measured output y to a high-pass filter F_{HP,j}(s), where F_{HP,j}(s) represents the jth high-pass filter. Filter F_{HP,j} (s) filters the measured output y and provides the filtered output to one of demodulation element 428-432. Each of demodulation elements 428-432 multiplies the output of the corresponding high-pass filter F_{HP,j}(s) by a demodulation signal d_{2,j}, where d_{2,j} represents the jth demodulation signal. Each of demodulation elements 428-432 then provides the product to a low-pass filter F_{LP,j}(s), where F_{LP,j}(s) represents the jth low-pass filter. The cutoff frequencies of high-pass filters 422-426 and low-pass filters 434-438 may be selected to extract gradient information from measured output y at a particular dither frequency. The frequency and phase of the demodulation signals d_{2,j} may be selected to maximize the cross-correlation between the demodulation signal d_{2,j} and the output of the corresponding high-pass filter F_{HP,j}(s).

Advantageously, using multiple different dither signals d_{1,j} and demodulation signals d_{2,j} allows each control input uⱼ to be independently isolated by defining different dither frequencies for each dither/demodulation signal pair. For example, dither signal d_{1,1} and demodulation signal d_{2,1} may both have a first frequency f₁, whereas dither signal d_{1,2} and demodulation signal d_{2,2} may both have a second frequency f₂, where f₁ is different from f₂. This allows each of control loops 401-405 to generate a different performance gradient pⱼ that is specific to the corresponding control input uⱼ. Accordingly, dither switching extremum seeking controller 402 can attribute a change in measured output y to a change in a particular control input uⱼ. Changes in the measured output y caused by each of control inputs uⱼ can be distinguished from each other and distinguished from changes caused by external disturbances and/or process noise.

Still referring to FIG. 4, dither switching extremum seeking controller 402 is shown to include hysteresis blocks 440-444 and flip-flops 446-450. In a typical dither ESC system, the performance gradients pⱼ would be provided directly to integrators 452-456. However, dither switching extremum seeking controller 402 passes the performance gradients pⱼ through hysteresis blocks 440-444 and flip-flops 446-450 before the gradients are provided to integrators 452-456.

In some embodiments, hysteresis blocks 440-444 and flip-flops 446-450 perform the functions of performance gradient stabilizer 314, as described with reference to FIG. 3B. For example, hysteresis blocks 440-444 may be configured to store a history of inputs from low-pass filters 434-438. Hysteresis blocks 440-444 may output a signal that is dependent not only on the current input from low-pass filters 434-438, but also on the stored history of past inputs. Advantageously, hysteresis blocks 440-444 may prevent rapid switching of the inputs provided to integrators 452-456. In some embodiments, flip-flops 446-450 are “D-type” flip-flop electronic circuit elements configured to capture the value of the output from hysteresis modules 440 at a definite portion of a clock cycle (e.g., at the rising edge). Flip-flops 446-450 may hold their outputs at the captured values for the duration of the clock cycle. Hysteresis blocks 440-444 and flip-flops 446-450 may be configured to stabilize the performance gradients pⱼ while rejecting the negative impact of noise n. The stabilized performance gradients are then provided to integrators 452-456 which operate to drive the performance gradients to zero, thereby optimizing the performance of dither switching extremum seeking controller 402.

Referring now to FIG. 5, a block diagram illustrating dither switching extremum seeking controller 402 in greater detail is shown, according to an exemplary embodiment. Controller 402 uses extremum seeking control logic to adjust the values for control inputs u₁, u₂, . . . , u_{N} to achieve a target value (e.g., a minimum value, a maximum value, a setpoint value, etc.) for a variable of interest affected by plant 404. In some operating modes, the control logic implemented by controller 402 utilizes feedback of an output variable y from plant 404 to determine the values for control inputs u₁, u₂, . . . , u_{N}. Controller 402 may receive feedback from plant 404 via input interface 418 and provide control inputs to plant via output interface 420.

In some embodiments, the logic implemented by controller 402 generates values for control inputs u₁, u₂, . . . , u_{N} based on a received control signal (e.g., a setpoint, an operating mode signal, etc.). The control signal may be received from a user control (e.g., a thermostat, a local user interface, etc.), client devices 514 (e.g., computer terminals, mobile user devices, cellular phones, laptops, tablets, desktop computers, etc.), a supervisory controller 514, or any other external system or device. In various embodiments, controller 402 may communicate with external systems and devices directly (e.g., using NFC, Bluetooth, WiFi direct, cables, etc.) or via a communications network 510 (e.g., a BACnet network, a LonWorks network, a LAN, a WAN, the Internet, a cellular network, etc.) using wired or wireless electronic data communications.

Still referring to FIG. 5, controller 402 is shown to include a communications interface 502, an input interface 418, and an output interface 420. Interfaces 418-420 and 502 may be or include any number of jacks, wire terminals, wire ports, wireless antennas, or other communications interfaces for communicating information and/or control signals. Interfaces 418-420 and 502 may be the same type of devices or different types of devices. For example, input interface 418 may be configured to receive an analog feedback signal (e.g., an output variable, a measured signal, a sensor output, a controlled variable) from plant 404, whereas communications interface 502 may be configured to receive a digital setpoint signal from upstream supervisory controller 512 via network 510. Output interface 420 may be a digital output (e.g., an optical digital interface) configured to provide a digital control signal (e.g., a manipulated variable, a control input) to plant 404. In other embodiments, output interface 420 is configured to provide an analog output signal.

In some embodiments interfaces 418-420 and 502 can be joined as one or two interfaces rather than three separate interfaces. For example, communications interface 502 and input interface 418 may be combined as one Ethernet interface configured to receive network communications from supervisory controller 512. In some embodiments, supervisory controller 512 provides both a setpoint and process feedback via an Ethernet network (e.g., network 510). In such an embodiment, output interface 420 may be specialized for a controlled process component of plant 404. In yet other embodiments, output interface 404 can be another standardized communications interface for communicating data or control signals. Interfaces 418-420 and 502 can include communications electronics (e.g., receivers, transmitters, transceivers, modulators, demodulators, filters, communications processors, communication logic modules, buffers, decoders, encoders, encryptors, amplifiers, etc.) configured to provide or facilitate the communication of the signals described herein.

Still referring to FIG. 5, controller 402 is shown to include a processing circuit 504 having a processor 506 and memory 508. Processor 506 may be a general purpose or specific purpose processor, an application specific integrated circuit (ASIC), one or more field programmable gate arrays (FPGAs), a group of processing components, or other suitable processing components. Processor 506 is configured to execute computer code or instructions stored in memory 508 or received from other computer readable media (e.g., CDROM, network storage, a remote server, etc.).

Memory 508 may include one or more devices (e.g., memory units, memory devices, storage devices, etc.) for storing data and/or computer code for completing and/or facilitating the various processes described in the present disclosure. Memory 508 may include random access memory (RAM), read-only memory (ROM), hard drive storage, temporary storage, non-volatile memory, flash memory, optical memory, or any other suitable memory for storing software objects and/or computer instructions. Memory 508 may include database components, object code components, script components, or any other type of information structure for supporting the various activities and information structures described in the present disclosure. Memory 508 may be communicably connected to processor 506 via processing circuit 504 and may include computer code for executing (e.g., by processor 506) one or more processes described herein.

Still referring to FIG. 5, memory 508 is shown to include a dither signal module 522. Dither signal module 522 may be configured to generate one or more dither signals for use in perturbing the control inputs u₁, u₂, . . . , u_{N} provided to plant 404. The number of dither signals generated by dither signal module 522 may depend on the number N of control inputs. In some embodiments, dither signal module 522 generates a dither signal d_{1,j} for each of the N control inputs, where d_{1,j} represents the jth dither signal.

Each dither signal d_{1,j} has an amplitude Aⱼ and a dither frequency fⱼ. The amplitude Aⱼ for a dither signal may be selected such that the input perturbation is no larger than 10% of the total input range. In some embodiments, the amplitude Aⱼ of a dither signal d_{1,j} is selected such that the corresponding dithered output amplitude (i.e., the amplitude of the effect of dither signal d_{1,j} in the output y from plant 404) is at least twice the noise amplitude. The dither frequency fⱼ for a dither signal d_{1,j} may be selected such that no two dither signals have the same dither frequency. For example, dither signal d_{1,1} may have a first frequency f₁ and dither signal d_{1,2} may have a second frequency f₂, where f₁ is different from f₂. Advantageously, using multiple different dither frequencies allows the effect of each control input uⱼ on the plant output y to be independently observed and used to optimize the control inputs. In some embodiments, the values of the dither amplitudes Aⱼ and/or dither frequencies fⱼ are determined by operating parameters generator 534. Dither signal module 522 may retrieve such values from operating parameters generator 534 and use the values to generate the dither signals.

Dither signal module 522 may include one or more processing elements (e.g., processing elements 458-462) configured to generate perturbed control inputs u₁, u₂, . . . , u_{N} using the generated dither signals. For example, dither signal module 522 may generate a perturbed control input uⱼ by adding a dither signal d_{1,j} to the output vⱼ provided by integration module 530 (e.g., uⱼ=vⱼ+d_{1,j}). In some embodiments, dither signal module 522 modifies each signal vⱼ using a different dither signal d_{1,j} having a different dither frequency. Dither signal module 522 may provide the perturbed control inputs u₁, u₂, . . . , u_{N} to plant 404 via output interface 420. The output signal y from plant 404 may be a function of the perturbed control inputs u₁, u₂, . . . , u_{N}.

Still referring to FIG. 5, memory 508 is shown to include a feedback filtration module 524. Feedback filtration module 524 may be configured to receive the feedback signal y from plant 404 via input interface 418 and to filter the feedback signal y using one or more high-pass filters and/or low-pass filters. The number of high-pass filters and low-pass filters used by feedback filtration module 524 may depend on the number N of control inputs. In some embodiments, feedback filtration module 524 includes a high-pass filter F_{HP,j}(s) and a low-pass filter F_{LP,j}(s) for each of the N control inputs, where F_{HP,j}(s) represents the jth high-pass filter and F_{LP,j}(s) represents the jth low-pass filter.

In some embodiments, the high-pass filters are arranged in parallel with each other (as shown in FIG. 4) such that each high-pass filter is positioned along a separate control loop. The low-pass filters may be arranged in parallel with each other and in series with the high-pass filters, along each control loop. The output of each high-pass filter may be provided to a demodulation element downstream of the high-pass filter and arranged in series with the high-pass filter along the corresponding control loop. The output of each demodulation element may be provided to the low-pass filter arranged downstream of the demodulation element and in series with both the demodulation element and the corresponding high-pass filter along the corresponding control loop.

The cutoff frequencies of each high-pass filter F_{HP,j}(s) and each low-pass filter F_{LP,j}(s) may be selected to facilitate extracting performance gradient information from the feedback signal y at a particular dither frequency fⱼ. For example, the pair of filters F_{HP,j}(s) and F_{LP,j}(s) arranged along control loop j may be configured to select for (i.e., pass through) frequency components of the feedback signal y at or near the dither frequency fⱼ. In some embodiments, the values of the cutoff frequencies are determined by operating parameters generator 534. Feedback filtration module 524 may retrieve such values from operating parameters generator 534 and use the values to tune the high-pass and low-pass filters.

Still referring to FIG. 5, memory 508 is shown to include a demodulation module 526. Demodulation signal module 526 may be configured to generate one or more demodulation signals for use in demodulating the outputs from the high-pass filters. The number of demodulation signals generated by demodulation module 526 may depend on the number N of control inputs. In some embodiments, demodulation module 526 generates a demodulation signal d_{2,j} for each of the N control inputs, where d_{2,j} represents the jth demodulation signal.

Each demodulation signal d_{2,j} may have a frequency fⱼ that matches the frequency of the corresponding dither signal d_{1,j}. For example, dither signal d_{1,1} and demodulation signal d_{2,1} may both have a first frequency f₁, whereas dither signal d_{1,2} and demodulation signal d_{2,2} may both have a second frequency f₂, where f₁ is different from f₂. In some embodiments, each demodulation signal d_{2,j} has a phase shift selected to maximize the cross-correlation between the demodulation signal d_{2,j} and the output of the corresponding high-pass filter F_{HP,j}(s). In some embodiments, the values demodulation frequencies fⱼ and the phase shifts for the demodulation signals are determined by operating parameters generator 534. Demodulation module 526 may retrieve such values from operating parameters generator 534 and use the values to generate the demodulation signals.

Demodulation module 526 may include one or more processing elements (e.g., processing elements 428-432) configured to multiply each demodulation signal d_{2,j} with the output of the corresponding high-pass filter F_{HP,j}(s). Demodulation module 526 may provide the product of each multiplication as an input to the corresponding low-pass filter F_{LP,j}(s). Advantageously, using multiple different dither signals d_{1,j} and demodulation signals d_{2,j} allows each control input uⱼ to be independently isolated by defining different dither frequencies for each dither/demodulation signal pair. Accordingly, dither switching extremum seeking controller 402 can attribute a change in measured output y to a change in a particular control input uⱼ. Changes in the measured output y caused by each of control inputs uⱼ can be distinguished from each other and distinguished from changes caused by external disturbances and/or process noise.

Still referring to FIG. 5, memory 508 is shown to include a gradient stabilization module 528. Gradient stabilization module 528 may receive the extracted performance gradients p₁, p₂, . . . , p_{N} from the low-pass filters and stabilize the performance gradients before the gradients provided to integration module 530. In various embodiments, gradient stabilization module 528 includes one or more hysteresis devices (e.g., hysteresis blocks 440-444) and/or flip-flop devices (e.g., flip-flops 446-450). The number of demodulation hysteresis devices and flip-flops may depend on the number N of control inputs. In some embodiments, gradient stabilization module 528 includes a hysteresis device Hⱼ and a flip-flop device F/Fⱼ for each of the N control inputs, where Hⱼ represents the jth hysteresis device and F/Fⱼ represents the jth flip-flop device.

Each hysteresis device Hⱼ may be configured to store a history of values output by the corresponding low-pass filter F_{LP,j}(s). Each hysteresis device Hⱼ may output a signal that is dependent not only on the current output from low-pass filter F_{LP,j}(s), but also on the stored history of past outputs. Advantageously, the hysteresis devices may prevent rapid switching of the performance gradients. In some embodiments, each flip-flop device F/Fⱼ is a “D-type” flip-flop electronic circuit element configured to capture the value of the output from the corresponding hysteresis device Hⱼ at a definite portion of a clock cycle (e.g., at the rising edge). The flip-flop devices may hold their outputs at the captured values for the duration of the clock cycle. Advantageously, gradient stabilization module 528 may be configured to stabilize the performance gradients pⱼ while rejecting the negative impact of noise n. Gradient stabilization module 528 may provide the stabilized performance gradients to integration module 530.

Still referring to FIG. 5, memory 508 is shown to include an integration module 530. Integration module 530 may receive the stabilized performance gradients from gradient stabilization module 528 and operate to drive the stabilized performance gradients to zero. Integration module 530 may include a plurality of integrators (e.g., integrators 452-456). The number of integrators may depend on the number N of control inputs. In some embodiments, integration module 530 includes an integrator Kⱼ/s for each of the N control inputs, where Kⱼ/s represents the jth integrator. Each integrator Kⱼ/s has an integral gain Kⱼ that may be defined by operating parameters generator 534. Each integrator Kⱼ/s may be configured to generate a value for the corresponding manipulated variable vⱼ that is subsequently modified by dither signal module 522 to generate the corresponding control input uⱼ. In some embodiments, integration module 530 generates manipulated variable values vⱼ that drive the corresponding performance gradient pⱼ to zero.

Still referring to FIG. 5, memory 508 is shown to include a system identification module 532. System identification module 532 may be configured to estimate the input dynamics and measurement noise of plant 404. In some embodiments, system identification module 532 uses open-loop tests to estimate the input dynamics and measurement noise. For example, system identification module 532 may identify a range of possible values for each of control inputs uⱼ. System identification module 532 may set each of control inputs uⱼ to a median of the possible input values for input uⱼ and provide plant 404 with a vector of such inputs until plant 404 reaches a steady state.

System identification module 532 may run a testing procedure for each input channel to identify the input dynamics and/or measurement noise of plant 404. Any of a variety of testing procedures may be used including, for example, a step/bump test, a double pulse test, and/or a pseudorandom binary sequence (e.g., for multi-input systems) followed by applying a system identification. For each input channel, system identification module 532 may start with the control input uⱼ at a midpoint of the input range and apply a perturbation to uⱼ. In some embodiments, the perturbation is approximately 10% or less of the total input range for the input channel. Such a level of perturbation may be suitable for input dynamics that are potentially nonlinear for a large input variation and also for the small perturbations applied by the dither signals by dither signal module 522.

System identification module 532 may generate transfer functions representing the input dynamics of each input channel. In some embodiments, the input dynamics are linear time-invariant (LTI) input dynamics having a transfer function of the form:

$${F}_{i , j} ( s ) = \frac{a}{bs + 1}$$

where F_{i,j}(s) represents the input dynamics of the jth input channel and a and b are parameters determined by system identification module 532. In some embodiments, the measurement noise is a zero-mean Gaussian noise having a distribution defined by the parameter σₙₒᵢₛₑ (e.g., a variance, a standard deviation, etc.) and an amplitude defined by the parameter Aₙₒᵢₛₑ. System identification module 532 may generate values for the parameters σₙₒᵢₛₑ and Aₙₒᵢₛₑ to define the noise distribution. System identification module 532 may provide the identified system parameters to operating parameters generator 534 for use in generating the operating parameters used by controller 402.

Still referring to FIG. 5, memory 508 is shown to include an operating parameters generator 534. Operating parameters generator 534 may be configured to generate one or more operating parameters used by controller 402. In some embodiments, operating parameters generator 534 generates frequency values fⱼ and amplitude values Aⱼ for the dither signals generated by dither signal module 522. Operating parameters generator 534 may generate a dither amplitude Aⱼ for each dither signal d_{1,j} that results in a dithered output amplitude Aⱼ′ (i.e., the effect of dither signal d_{1,j} observed in plant output y) of at least twice the amplitude of the measurement noise determined by system identification module 532 (i.e., Aⱼ′≧Aₙₒᵢₛₑ).

In some embodiments, the dithered output amplitude Aⱼ′ for a given input channel j is proportional to the amplitude of the corresponding dither signal Aⱼ (i.e., Aⱼ′∝Aⱼ). Therefore, operating parameters generator 534 can estimate the dither signal amplitude Aⱼ that will result in the desired dithered output amplitude Aⱼ′ (e.g., twice the measurement noise) based on a result of the system identification performed by system identification module 532. For example, operating parameters generator 534 may record the magnitude Xⱼ of the perturbation applied to the control input uⱼ during system identification and observe the corresponding output amplitude Yⱼ in the plant output y. Operating parameters generator 534 may calculate a gain value Gₚ such that the product of the gain value and the dithered output amplitude is at least twice the measurement noise amplitude (i.e., Yⱼ·Gₚ≧Aₙₒᵢₛₑ). Operating parameters generator 534 may then multiply the recorded perturbation amplitude Xⱼ by the calculated gain value Gₚ to determine the value of the dither signal amplitude Aⱼ (i.e., Aⱼ=Gₚ·Xⱼ)

Operating parameters generator 534 may generate frequency values, amplitude values, and phase compensation values for the demodulation signals generated by demodulation module 526. In some embodiments, operating parameters generator 534 determines the phase compensation values for each demodulation signal d_{2,j} that maximizes the cross-correlation between the demodulation signal d_{2,j} and the output of the corresponding high-pass filter F_{HP,j}(s). For example, operating parameters generator 534 may select an initial phase compensation value and perform open-loop testing to tune the phase compensation until the cross-correlation between the demodulation signal d_{2,j} and the corresponding high-pass filter F_{HP,j} (s) is maximized.

Operating parameters generator 534 may select cutoff frequencies for the high-pass filters and the low-pass filters. In some embodiments, operating parameters generator 534 selects cutoff frequencies such that each pair of high-pass and low-pass filters selects for (i.e., passes through) frequency components in a range around a particular dither signal frequency. Operating parameters generator 534 may select integral gain values for each of the integrators used to drive the performance gradients to zero. In some embodiments, some or all of the operating parameters generated by operating parameters generator 534 can be adaptively adjusted (i.e., tuned) by adaptive tuning module 538.

Still referring to FIG. 5, memory 508 is shown to include a closed-loop control module 536. Closed-loop control module 536 may be configured to operate controller 402 in a closed-loop operating mode. In the closed-loop operating mode, controller 402 receives an output y from plant 404 and passes the output y through a plurality of parallel high-pass filters. The high-pass filters have different cutoff frequencies that select for different frequency components in the plant output y. The output from each high-pass filter F_{HP,j}(s) is multiplied by a corresponding demodulation signal d_{2,j} that maximizes the cross-correlation therebetween. The product of each multiplication is provided to a corresponding low-pass filter F_{LP,j}(s) that operates to extract a performance gradient pⱼ. The performance gradients are provided to one or more hysteresis devices and/or flip-flops that stabilize the performance gradients. The stabilized performance gradients are then provided to integrators that operate to drive the stabilized performance gradients to zero by generating a value vⱼ for each a plurality of manipulated variables. Each of the values vⱼ is modified by a dither signal d_{1,j} to generate a perturbed control input uⱼ. The perturbed control inputs uⱼ are provided as inputs to plant 404.

Still referring to FIG. 5, memory 508 is shown to include an adaptive tuning module 538. Adaptive tuning module 538 may be configured to adaptively adjust the operating parameters used by controller 402 during closed-loop operation. In some embodiments, adaptive tuning module 538 monitors the output signal y from plant 404 during closed-loop operation and determines whether the dither signals applied to the control inputs have an observable effect (e.g., a dithered output amplitude) exceeding a threshold value. If the plant output y remains monotonic for a threshold time period, adaptive tuning module 538 may increase (e.g., double) the integral gain values Kⱼ used by integration module 530.

Adaptive tuning module 538 may determine whether the change in integral gain values causes the plant output y to enter a hunting scenario (e.g., large amplitude oscillation in a triangular pattern) in which the performance gradients pⱼ are driven toward zero. If the change does not initiate the hunting scenario, adaptive tuning module 538 may continue to increase the gain values Kⱼ until the hunting scenario begins. Once the output y enters the hunting scenario, adaptive tuning module 538 may adjust the integral gain values Kⱼ until the output oscillation magnitude is less than an acceptable amplitude threshold. In some embodiments, adaptive tuning module 538 adaptively adjusts the phase compensation of the demodulation signals d_{2,j} during closed-loop operation to maximize the cross-correlation between each dither signal d_{2,j} and the output of the corresponding high-pass filter F_{HP,j}(s).

Referring now to FIG. 6, a flowchart of a process 600 for regulating a variable of interest affected by a plant using dither switching extremum seeking control is shown, according to an exemplary embodiment. Process 600 may be performed by dither switching extremum seeking controller 402, as described with reference to FIGS. 4-5.

Process 600 is shown to include receiving an output signal from a plant (step 602). The plant may be the same or similar to plant 404. For example, the plant may be a combination of a process and one or more mechanically-controlled outputs. The output signal may be a feedback signal from the plant (e.g., plant output y) and may be received at a communications interface of the controller. In some embodiments, the output signal is a function of a plurality of control inputs to the plant.

Process 600 is shown to include extracting a performance gradient from the output signal for each of a plurality of control inputs to the plant (step 604). Each performance gradient may be specific to a particular control input and may represent the slope of a performance curve defining the variable of interest as a function of the control input. The performance curve may have an extremum (e.g., a minimum or a maximum) when the performance gradient (i.e., the slope of the performance curve) is zero. The variable of interest can be optimized for each control input by providing a value of the control input that drives the corresponding performance gradient to zero, thereby moving the variable of interest toward the extremum.

In some embodiments, step 604 is performed by demodulation module 526, as described with reference to FIG. 5. For example, step 604 may include isolating an effect of each dither signal on the output signal and using the isolated effect of each dither signal to determine a relationship between each of the control inputs and the variable of interest. Isolating the effect of each dither signal on the output signal may include filtering the output signal using a plurality of parallel high-pass filters, applying a demodulation signal to an output of each high-pass filter to generate a plurality of demodulated output signals, and filtering the plurality of demodulated output signals using a plurality of parallel low-pass filters. In some embodiments, a plurality of demodulation signals are generated and used in step 604. Each high-pass filter output may be multiplied by a different demodulation signal. In some embodiments, each demodulation signals is configured to maximize a cross-correlation between the demodulation signal and the output of the corresponding high-pass filter. For example, the demodulation signal may have a frequency matching the frequency of the corresponding dither signal and a phase compensation that maximizes the cross-correlation.

Still referring to FIG. 6, process 600 is shown to include stabilizing the extracted performance gradients using a history of previous values for the extracted performance gradients (step 606). In some embodiments, step 606 is performed by gradient stabilization module 528, as described with reference to FIG. 5. For example, step 606 may include using one or more hysteresis devices and/or flip-flop devices to stabilize the extracted performance gradients. In some embodiments, step 606 includes using a plurality of parallel stabilization elements (e.g., hysteresis devices and/or flip-flop devices) to independently process and stabilize each of the extracted performance gradients.

Each hysteresis device may be configured to store a history of values output by the corresponding low-pass filter. Each hysteresis device may output a signal that is dependent not only on the current output from low-pass filter, but also on the stored history of past outputs. The hysteresis devices may prevent rapid switching of the performance gradients. In some embodiments, each flip-flop device is a “D-type” flip-flop electronic circuit element configured to capture the value of the output from the corresponding hysteresis device at a definite portion of a clock cycle (e.g., at the rising edge). The flip-flop devices may hold their outputs at the captured values for the duration of the clock cycle. Step 606 may be used to stabilize the performance gradients while rejecting the negative impact of noise.

Still referring to FIG. 6, process 600 is shown to include generating values for the plurality of control inputs that drive the stabilized performance gradients toward zero (step 608). In some embodiments, step 608 is performed by integration module 530, as described with reference to FIG. 5. Step 608 may include using a plurality of parallel integrators to independently process each of the stabilized performance gradients. Each stabilized performance gradient may correspond to one of the control inputs. Step 608 may include using each integrator to determine a value for one of the control inputs that drives the corresponding stabilized performance gradient to zero. In some embodiments, each integrator has an integral gain parameter that can be modified (e.g., via process 700) to adaptively tune the integrator during closed-loop operation.

Process 600 is shown to include perturbing the plurality of control inputs by adding a dither signal to each control input (step 610). In some embodiments, step 610 is performed by dither signal module 522, as described with reference to FIG. 5. In some embodiments, step 610 includes generating a plurality of dither signals. The number of dither signals generated in step 610 may depend on the number of control inputs. In some embodiments, a dither signal is generated for each of the control inputs. Each dither signal may have a different dither frequency. Step 610 may include adding the plurality of generated dither signals to the control inputs such that each control input is perturbed by a dither signal having a different dither frequency.

Still referring to FIG. 6, process 600 is shown to include providing the perturbed control inputs to the plant via the communications interface of the controller (step 612). The plant may use the perturbed control inputs to perform various control actions (e.g., operating an actuator, closing a damper, turning on/off chillers, fans, power relays, etc.) that affect the value of the variable of interest. The plant generates an output signal indicative of the variable of interest, which is provided to the controller. Process 600 may be performed iteratively and may return to step 602 after performing step 612.

Referring now to FIG. 7, a flowchart of a process 700 for adaptively tuning a dither switching extremum seeking controller is shown, according to an exemplary embodiment. Process 700 may be performed by dither switching extremum seeking controller 402, as described with reference to FIGS. 4-5, to automatically determine and/or update one or more control parameters used by controller 402 during closed-loop operation.

Process 700 is shown to include estimating input dynamics and measurement noise of a plant (step 702). In some embodiments, step 702 is performed by system identification module 532, as described with reference to FIG. 5. Step 702 may include using open-loop tests to estimate the input dynamics and measurement noise. For example, step 702 may include identifying a range of possible values for each of the control inputs and setting each of control inputs to a median of the possible input. A vector of the median input values may be provided to the plant until the plant reaches a steady state. Any of a variety of testing procedures may be used including, for example, a step/bump test, a double pulse test, and/or a pseudorandom binary sequence (e.g., for multi-input systems) followed by applying a system identification. In one embodiment, the testing procedure includes setting the value of each control input at a midpoint of the input range and applying a perturbation to the control input. In some embodiments, the perturbation is approximately 10% or less of the total input range for the input channel. Such a level of perturbation may be suitable for input dynamics that are potentially nonlinear for a large input variation and also for the small perturbations applied by the dither signals.

Step 702 may include generating transfer functions representing the input dynamics of each input channel. In some embodiments, the input dynamics are linear time-invariant (LTI) input dynamics having a transfer function of the form:

$${F}_{i , j} ( s ) = \frac{a}{bs + 1}$$

where F_{i,j}(s) represents the input dynamics of the jth input channel and a and b are parameters determined by the testing procedure. In some embodiments, the measurement noise is a zero-mean Gaussian noise having a distribution defined by the parameter σₙₒᵢₛₑ (e.g., a variance, a standard deviation, etc.) and an amplitude defined by the parameter Aₙₒᵢₛₑ. Step 702 may include generating values for the parameters σₙₒᵢₛₑ and Aₙₒᵢₛₑ to define the noise distribution.

Still referring to FIG. 7, process 700 is shown to include calculating an amplitude for the dither signal based on the estimated measurement noise (step 704). In some embodiments, step 704 is performed by operating parameters generator 534, as described with reference to FIG. 5. Step 704 may include identifying a dithered output amplitude of an oscillation in the output signal caused by the dither signal. In some embodiments, the dithered output amplitude Aⱼ′ for a given input channel j is proportional to the amplitude of the corresponding dither signal Aⱼ (i.e., Aⱼ′∝Aⱼ). This proportionality can be used to determine the dither signal amplitude Aⱼ that will result in the desired dithered output amplitude Aⱼ′ (e.g., twice the measurement noise). For example, step 704 may include recording the magnitude Xⱼ of the perturbation applied to a particular control input during system identification and observe the corresponding output amplitude Yⱼ in the plant output y.

Step 704 may include calculating a gain value that, when applied to the dithered output amplitude, results in an amplitude of at least twice the estimated measurement noise. The calculated gain value may be applied to an existing dither signal amplitude to generate a new amplitude for the dither signal. For example, step 704 may include calculating a gain value Gₚ such that the product of the gain value and the dithered output amplitude is at least twice the measurement noise amplitude (i.e., Yⱼ·Gₚ≧Aₙₒᵢₛₑ). The recorded perturbation amplitude Xⱼ may then be multiplied by the calculated gain value Gₚ to determine the value of the dither signal amplitude Aⱼ (i.e., Aⱼ=Gₚ·Xⱼ).

Still referring to FIG. 7, process 700 is shown to include perturbing a control input for the plant using the dither signal (step 706), extracting a performance gradient from an output signal from the plant (step 708), and generating a value for the control input that drives the extracted performance gradient toward zero (step 710). Steps 706-710 may be the same or similar to steps 610, 604, and 608, respectively, as described with reference to FIG. 6.

Process 700 is shown to include adaptively tuning a control parameter used by the controller based on an observed effect of the dither signal on the output signal from the plant (step 712). In some embodiments, step 712 is performed by adaptive tuning module 538, as described with reference to FIG. 5. For example, step 712 may include adaptively adjusting the operating parameters used by controller 402 during closed-loop operation. In some embodiments, step 712 includes identifying a dithered output amplitude of an oscillation in the output signal caused by the dither signal and comparing the dithered output amplitude to a threshold value. Step 712 may include adjusting, based on a result of the comparison, an integral gain parameter used by the integration module to generate the value for the control input. For example, step 712 may include monitoring the output signal from the plant during closed-loop operation and determines whether the dither signals applied to the control inputs have an observable effect (e.g., a dithered output amplitude) exceeding a threshold value. If the plant output remains monotonic for a threshold time period, step 712 may include increasing (e.g., doubling) the integral gain parameter.

In some embodiments, step 712 includes determining whether the change in the integral gain value causes the plant output to enter a hunting scenario (e.g., large amplitude oscillation in a triangular pattern) in which the performance gradients are driven toward zero. If the change does not initiate the hunting scenario, step 712 may include continuing to increase the gain value until the hunting scenario begins. Once the output enters the hunting scenario, step 712 may include adjusting the integral gain value until the output oscillation magnitude is less than an acceptable amplitude threshold.

In some embodiments, extracting the performance gradient in step 706 includes filtering the output signal from the plant using a high-pass filter and applying a demodulation signal to an output of the high-pass filter. In such embodiments, step 712 may include adjusting a phase compensation of the demodulation signal to optimize a cross-correlation between the demodulation signal and the output of the high-pass filter. Step 712 may include adjusting any of a variety of control parameters including, for example, integral gain parameters, dither frequency parameters, demodulation frequency parameters, demodulation signal phase compensation parameters, cutoff frequency parameters, system identification parameters, and/or any other parameters that may be used by controller 402 during closed-loop operation.

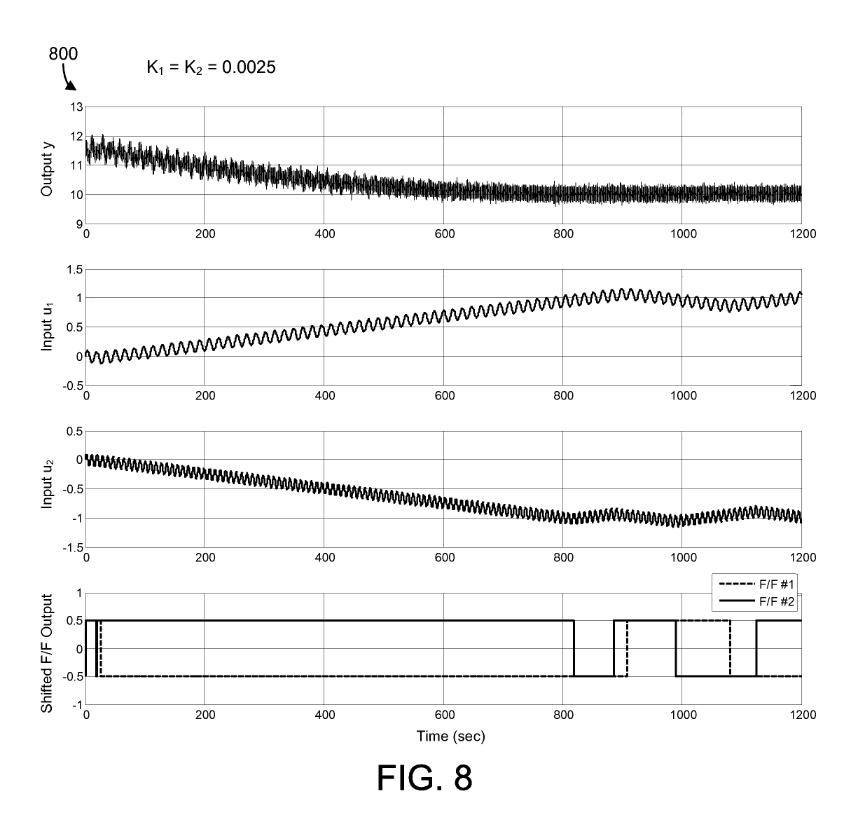

Referring now to FIGS. 8-14, a series of graphs 800-1400 illustrating the results of a simulation study are shown, according to an exemplary embodiment. In the simulation study, dither switching extremum seeking controller 402 is used to control a simulated plant that generates an output signal y as a function of two controlled inputs u₁ and u₂. The simulated plant operates according to the equation:

y=(u₁−1)²+(u₂+1)²+0.5(u₁−1)(u₂+1)+10

where the minimum output is y=10, which occurs at u₁=1 and u₂=−1.

The simulated plant is configured substantially as shown in FIG. 4 with input dynamics F_{i,1}(s) and F_{i,2}(s) defined as follows:

$${F}_{i , 1} ( s ) = \frac{1}{s + 1}$$

$${F}_{i , 2} ( s ) = \frac{1}{0.5 s + 1}$$

and output dynamics F₀(s) defined as follows:

$${F}_{0} ( s ) = \frac{100}{{s}^{2} + 14.14 s + 100}$$

The measurement noise n of the plant is a zero-mean Gaussian noise with σ²=10⁻⁴.

In the simulation study, controller 402 applies dither signals d_{1,1} and d_{1,2} to the inputs u₁ and u₂, respectively, and provides the perturbed inputs to the simulated plant. The first dither signal d_{1,1} has an amplitude A₁ and a dither frequency f₁ as follows:

$${A}_{1} = 0.1$$

$${f}_{1} = 0.4 \frac{rad}{sec}$$

and the second dither signal d_{1,2} has an amplitude A₂ and a dither frequency f₂ as follows:

$${A}_{2} = 0.1$$

$${f}_{2} = 0.7 \frac{rad}{sec}$$

The output y from the simulated plant is provided to two parallel high-pass filters F_{HP,1}(s) and F_{HP,2}(s) arranged as shown in FIG. 4 and defined by the equations:

$${F}_{HP , 1} ( s ) = \frac{{s}^{2}}{{s}^{2} + 0.36 s + 0.09}$$

$${F}_{HP , 2} ( s ) = \frac{{s}^{2}}{{s}^{2} + 0.72 s + 0.36}$$

The outputs from high-pass filters F_{HP,1}(s) and F_{HP,2}(s) are demodulated and provided to respective low-pass filters F_{LP,1}(s) and F_{LP,2}(s) as shown in FIG. 4 and defined by the equations:

$${F}_{LP , 1} ( s ) = \frac{0.04}{{s}^{2} + 0.24 s + 0.04}$$

$${F}_{LP , 2} ( s ) = \frac{0.16}{{s}^{2} + 0.48 s + 0.16}$$

The outputs from low-pass filters F_{LP,1}(s) and F_{LP,2}(s) are provided to respective stabilization elements (e.g., D flip-flops) with a clock input held constant at 1 and a relay interval set to [−0.01, 0.01]. The outputs of the stabilization elements are shifted down by 0.5, resulting in stabilized outputs of ±0.5. The shifted outputs are provided to integrators K₁/s and K₂/s, where the values K₁ and K₂ define the integral gains.

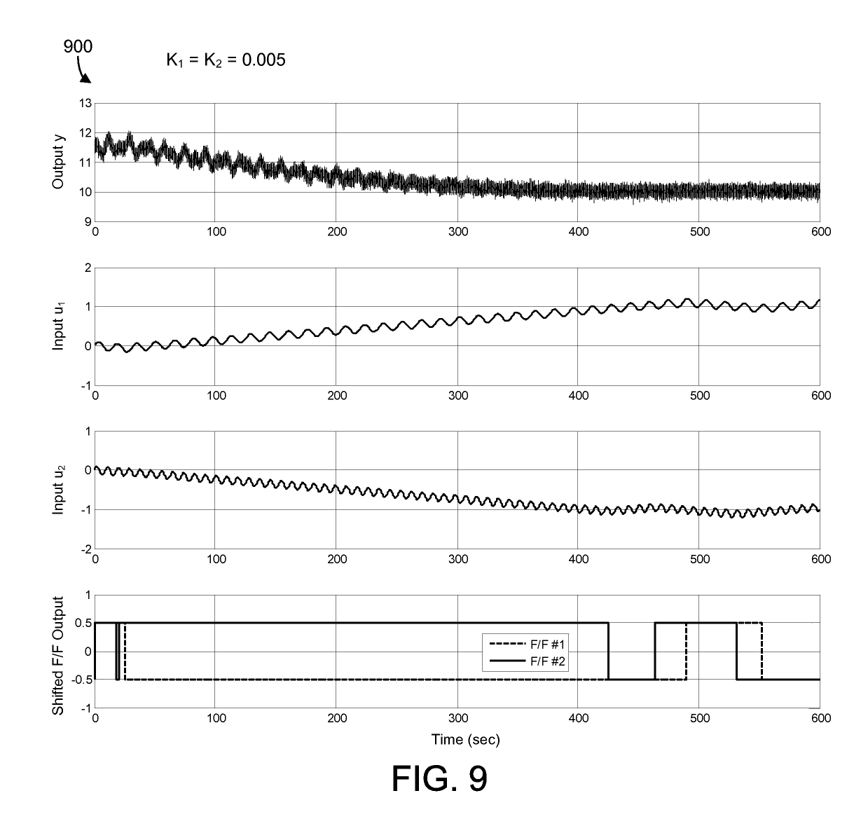

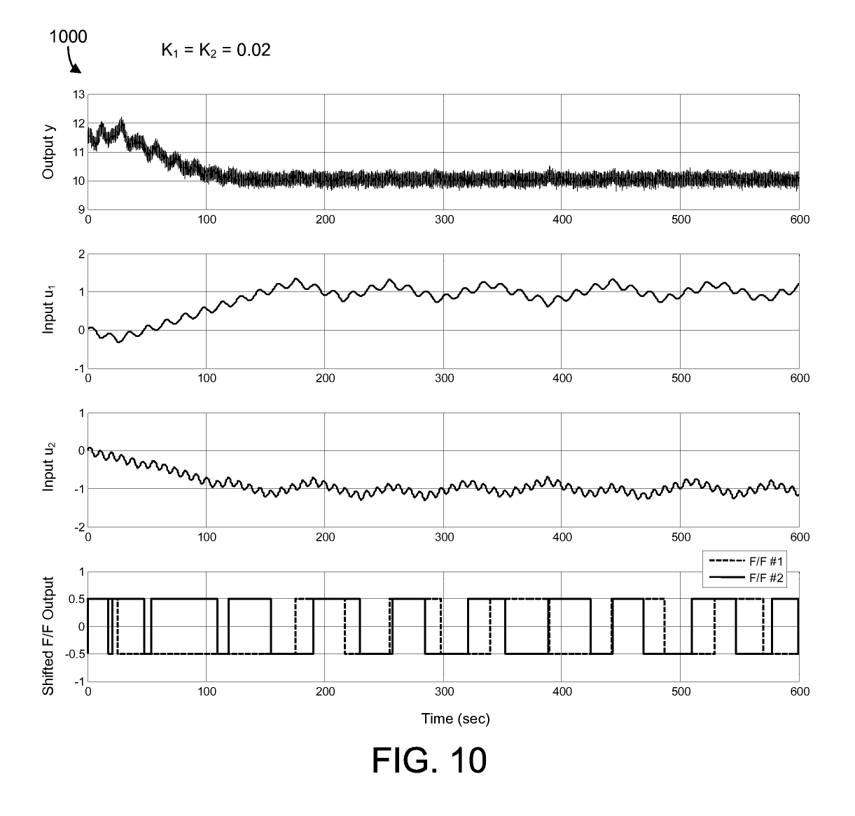

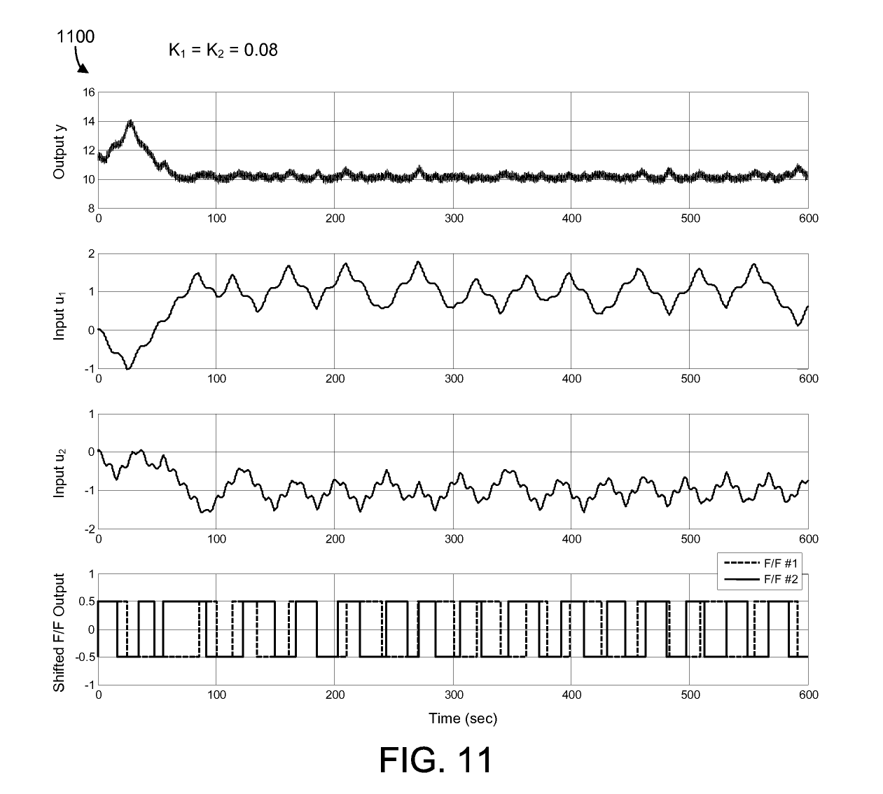

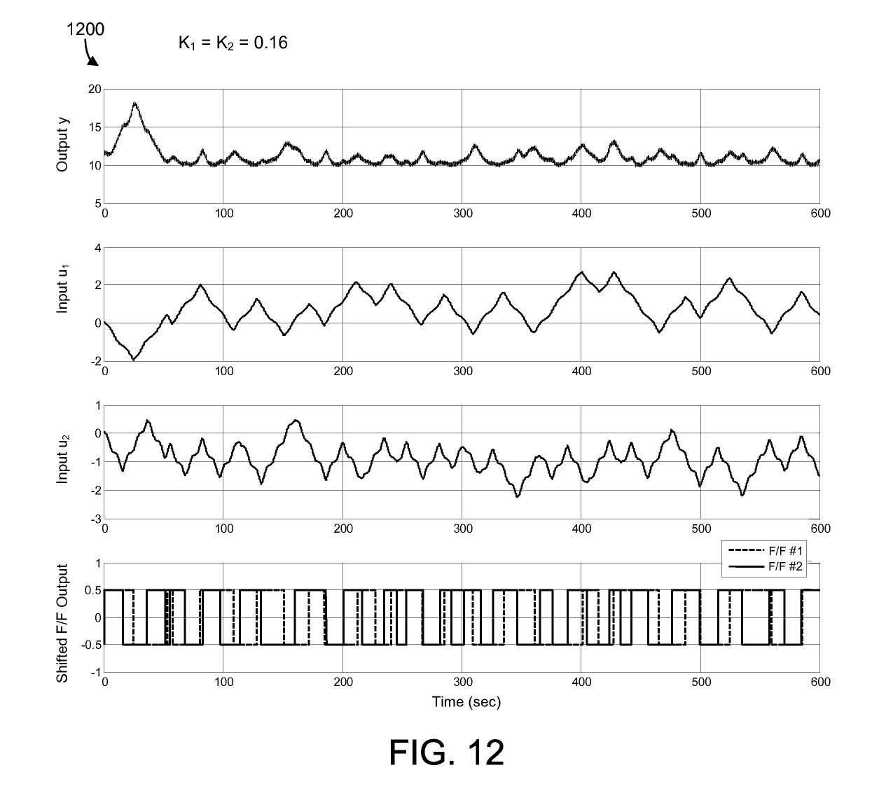

Each of graphs 800-1400 illustrates the values of the plant output y, the first input u₁, the second input u₂, and the shifted output of the stabilization elements as a function of time. Referring specifically to FIGS. 8-12, graphs 800-1200 show the results of the simulation study when the integral gains K₁ and K₂ are identical. Graph 800 (FIG. 8) shows the results when gains K₁=K₂=0.0025. Graph 900 (FIG. 9) shows the results when gains K₁=K₂=0.005. Graph 1000 (FIG. 10) shows the results when gains K₁=K₂=0.02. Graph 1100 (FIG. 11) shows the results when gains K₁=K₂=0.08. Graph 1200 (FIG. 12) shows the results when gains K₁=K₂=0.16.

Graphs 800-1200 demonstrate several advantages of the dither switching extremum seeking control framework with respect to the changes in gains K₁ and K₂. Increasing gains K₁ and K₂ results in an increasing convergence time and a decreasing oscillation magnitude, but does not affect asymptotic convergence. When gains K₁ and K₂ are increased to a large amplitude, the output y has a large but regular oscillatory pattern of increasing amplitude. The range for acceptable gain values is significantly larger than previous ESC techniques. The output y has mononic (and more tractable) patterns, which can facilitate the development of auto-tuning algorithms.

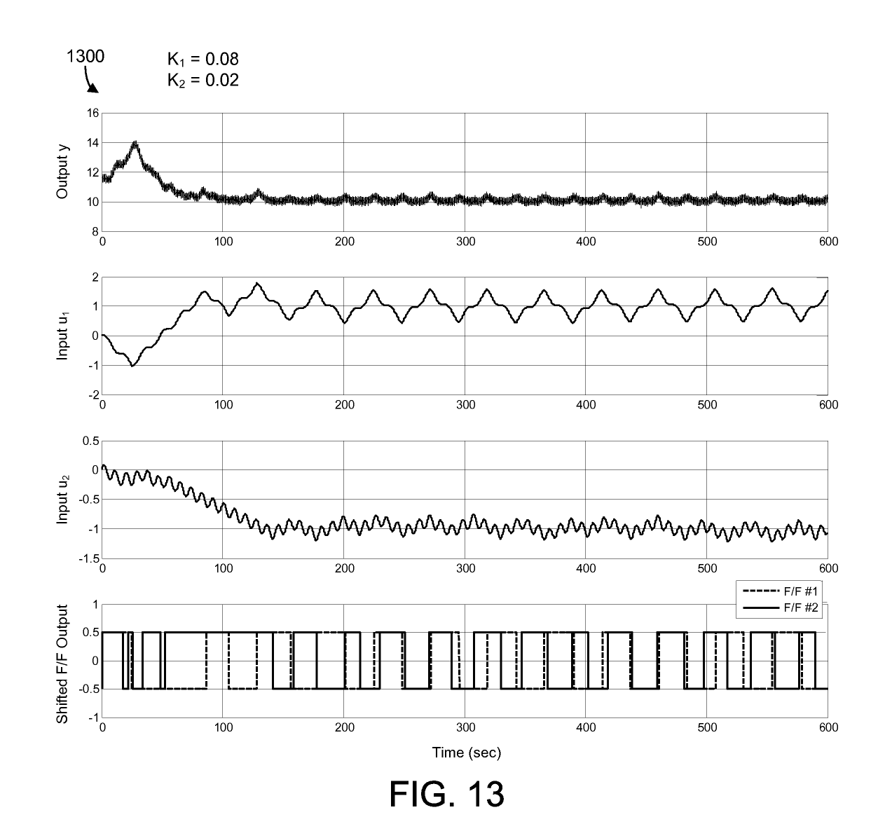

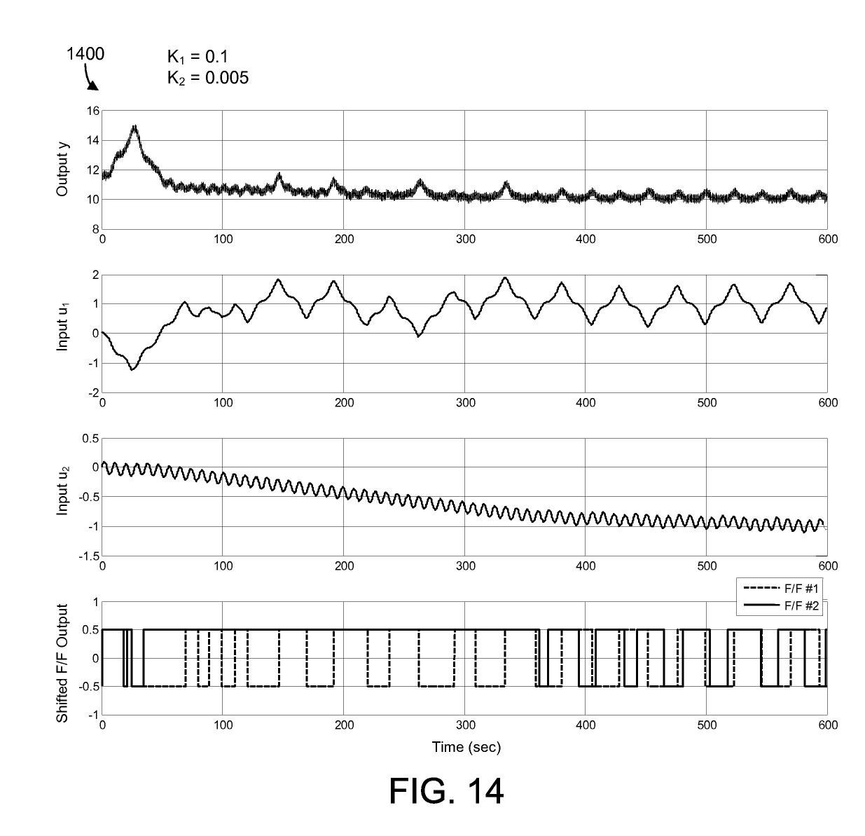

Referring specifically to FIGS. 13-14, graphs 1300-1400 show the results of the simulation study when the integral gains K₁ and K₂ are different. Graph 1300 (FIG. 13) shows the results when gain K₁=0.08 and gain K₂=0.02. Graph 1400 (FIG. 14) shows the results when gain K₁=0.1 and gain K₂=0.005. Graphs 1300-1400 demonstrate that the performance of controller 402 is not much affected by dramatically different loop gains for the various processing loops.

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

What is claimed is:

1. A dither switching extremum seeking controller comprising:
a communications interface configured to receive an output signal from a plant and provide a plurality of control inputs to the plant, wherein the output signal is a function of the control inputs;
a demodulation module configured to extract, from the output signal, a performance gradient for a variable of interest affected by the plant for each of the control inputs;
a stabilization module configured to stabilize the extracted performance gradients using a history of previous values for the extracted performance gradients;
an integration module configured to generate values for the control inputs, the generated values driving the stabilized performance gradients toward zero; and
a dither signal module configured to perturb the control inputs by adding a dither signal to each control input, wherein the perturbed control inputs are provided to the plant via the communications interface.

2. The controller of claim 1, further comprising:
a plurality of control loops each configured to independently perform the extract, stabilize, generate, and perturb operations for one of the control inputs.

3. The controller of claim 1, wherein the dither signal module is configured to:
generate a plurality of dither signals, each dither signal having a different dither frequency; and
add the plurality of generated dither signals to the control inputs such that each control input is perturbed by a dither signal having a different dither frequency.

4. The controller of claim 1, wherein the demodulation module is configured to:
isolate an effect of each dither signal on the output signal; and
use the isolated effect of each dither signal to determine a relationship between each of the control inputs and the variable of interest.

5. The controller of claim 4, wherein isolating the effect of each dither signal on the output signal comprises:
filtering the output signal using a plurality of parallel high-pass filters;
applying a demodulation signal to an output of each high-pass filter to generate a plurality of demodulated output signals; and
filtering the plurality of demodulated output signals using a plurality of parallel low-pass filters.

6. The controller of claim 5, wherein applying a demodulation signal to the output of each high-pass filter comprises:
generating a plurality of demodulation signals; and
multiplying the generated demodulation signals with the outputs from the high-pass filters such that each of the outputs from the high-pass filters is multiplied by a different demodulation signal;
wherein each demodulation signal configured to maximize a cross-correlation between the demodulation signal and the output of the high-pass filter with which the demodulation signal is multiplied.

7. The controller of claim 1, wherein the stabilization module is configured to:
use a plurality of parallel stabilization elements to independently process and stabilize each of the extracted performance gradients, the stabilization elements comprising at least one of a hysteresis device and a flip-flop device.

8. The controller of claim 1, wherein the integration module is configured to:
use a plurality of parallel integrators to independently process each of the stabilized performance gradients, wherein each stabilized performance gradient corresponds to one of the control inputs; and
generate a value for each of the control inputs that drives the corresponding stabilized performance gradient to zero.

9. A method for regulating a variable of interest affected by a plant using dither switching extremum seeking control, the method comprising:
receiving an output signal from the plant at a communications interface of a controller;
extracting, from the output signal by a demodulation module of the controller, a performance gradient for the variable of interest affected by the plant for each of a plurality of control inputs to the plant;
stabilizing, by a stabilization module of the controller, the extracted performance gradients using a history of previous values for the extracted performance gradients;
generating, by an integration module of the controller, values for the plurality of control inputs, the generated values driving the stabilized performance gradients toward zero;
perturbing, by a dither signal module of the controller, the plurality of control inputs by adding a dither signal to each control input; and
providing the perturbed control inputs to the plant via the communications interface of the controller, wherein the output signal from the plant is a function of the perturbed control inputs.

10. The method of claim 9, wherein the controller comprises a plurality of control loops and each of the control loops independently performs the extracting, stabilizing, generating, and perturbing steps for one of the control inputs.

11. The method of claim 9, wherein perturbing the plurality of control inputs comprises:
generating a plurality of dither signals, each dither signal having a different dither frequency; and
adding the plurality of generated dither signals to the control inputs such that each control input is perturbed by a dither signal having a different dither frequency.

12. The method of claim 9, wherein extracting the performance gradient comprises:
isolating an effect of each dither signal on the output signal; and
using the isolated effect of each dither signal to determine a relationship between each of the control inputs and the variable of interest.

13. The method of claim 12, wherein isolating the effect of each dither signal on the output signal comprises:
filtering the output signal using a plurality of parallel high-pass filters;
applying a demodulation signal to an output of each high-pass filter to generate a plurality of demodulated output signals; and
filtering the plurality of demodulated output signals using a plurality of parallel low-pass filters.

14. The method of claim 13, wherein applying a demodulation signal to the output of each high-pass filter comprises:
generating a plurality of demodulation signals; and
multiplying the generated demodulation signals with the outputs from the high-pass filters such that each of the outputs from the high-pass filters is multiplied by a different demodulation signal;
wherein each demodulation signal configured to maximize a cross-correlation between the demodulation signal and the output of the high-pass filter with which the demodulation signal is multiplied.

15. The method of claim 9, wherein stabilizing the extracted performance gradients comprises:
using a plurality of parallel stabilization elements to independently process and stabilize each of the extracted performance gradients, the stabilization elements comprising at least one of a hysteresis device and a flip-flop device.

16. The method of claim 9, wherein generating values for the plurality of control inputs comprises:
using a plurality of parallel integrators to independently process each of the stabilized performance gradients, wherein each stabilized performance gradient corresponds to one of the control inputs; and
generating, by each of the integrators, a value for one of the control inputs that drives the corresponding stabilized performance gradient to zero.

17. A dither switching extremum seeking controller comprising:
a dither signal module configured to perturb a control input for a plant using a dither signal;
a demodulation module configured to extract a performance gradient from an output signal from the plant;
an integration module configured to generate a value for the control input that drives the extracted performance gradient toward zero; and
an adaptive tuning module configured to adaptively tune a control parameter used by the controller based on an observed effect of the dither signal on the output signal from the plant.

18. The controller of claim 17, wherein the adaptive tuning module is configured to:
identify a dithered output amplitude of an oscillation in the output signal caused by the dither signal;
compare the dithered output amplitude to a threshold value; and
based on a result of the comparison, adjust an integral gain parameter used by the integration module to generate the value for the control input.

19. The controller of claim 17, wherein the demodulation module is configured to filter the output signal from the plant using a high-pass filter and apply a demodulation signal to an output of the high-pass filter;
wherein the adaptive tuning module is configured to adjust a phase compensation of the demodulation signal to optimize a cross-correlation between the demodulation signal and the output of the high-pass filter.

20. The controller of claim 17, further comprising:
a system identification module configured to estimate a measurement noise of the plant; and
an operating parameters generator module configured to calculate an amplitude for the dither signal based on the estimated measurement noise.
